(19) United States
(12) Patent Application Publication
(10) Pub. No.: US 2010/0114550 A1
(43) Pub. Date: May 6, 2010

(54) Modeling Device, Simulation Device, Modeling Program, Simulation Program, Method for Using Heat Balance Model, and System for Using Heat Balance Model

(75) Inventors: Tadato Fujihara, Osaka (JP); Yoshio Ozawa, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co., Ltd., Moriguchi-shi, Osaka (JP)

(21) Appl. No.: 12/440,302

(22) PCT Filed: Sep. 6, 2007
(86) PCT No.: PCT/JP07/67439

§ 371 Date: Jan. 5, 2010

(30) Foreign Application Priority Data
Sep. 8, 2006 (JP) 2006-244514
Aug. 27, 2007 (JP) 2007-219840

(51) Int. Cl. G06F 17/50; G06F 19/00

(52) U.S. Cl. 703/13

(57) ABSTRACT

Disclosed is a modeling device, including: a classification unit (120) configured to classify measurement data acquired in order to identify a parameter required to construct a heat balance model for a facility (10) containing an outdoor unit (11), an indoor unit (12), an outdoor unit (21), an indoor unit (22), a condensing unit (31), a condensing unit (41), and the like, according to classification conditions affecting the parameter; and an identification unit (130) configured to identify the parameter for each of the classification conditions, based on the measurement data classified according to the classification conditions.

### TECHNICAL FIELD

The present invention relates to a modeling device and modeling program for constructing a heat balance model for a facility containing a plurality of equipments, a simulation device and simulation program for predicting energy consumption of equipment by using a heat balance model, and a method and a system for using the heat balance model

### BACKGROUND ART

Heretofore, a method for using a heat balance model has been known as a method for predicting energy consumption of each equipments in a facility (e.g., a supermarket or a convenience store) containing a plurality of equipments (e.g., an air conditioner, a refrigerator, a freezer, and a freezing/refrigerating showcase).

Construction of the heat balance model involves calculating heat load applied to the facility or heat load applied to the equipment, and also calculating a coefficient of performance (COP) of the equipment.

Specifically, the calculation of the heat load applied to the facility is performed by dividing glass windows, an outer wall, a roof and the like provided in the facility into multiple areas, and calculating a heat transfer coefficient, a sunlight radiation heat coefficient, a ventilation coefficient, or the like, on an area-by-area basis.

The heat load applied to the equipment is calculated, considering the influence of each equipments upon each other, the heat load applied to the facility, or the like. The COP of the equipment is calculated, based on the heat load applied to the equipment and the energy consumption.

As mentioned above, the construction of the heat balance model requires the area-by-area calculation of the heat transfer coefficient or the like and also the calculation of the COP of each equipments. Data required for the construction of the heat balance model, such as the heat transfer coefficient and the COP of the equipment, will be hereinafter referred to as “parameters.”

For a conventional heat balance model, the construction of a highly accurate heat balance model requires consideration of various heat loads, and thus requires identification of many parameters. Incidentally, the various heat loads include heat loads acting on the air conditioner and showcase installed in the facility, and heat loads acting on subareas where the inside and outside of the facility are subdivided.

Also, in order to perform a highly accurate prediction, it is necessary to identify the COP of each equipments, which changes according to temperature and humidity inside and outside the facility, operation mode of the equipment, the setting value of the equipment, the magnitude of process heat load, and the like.

Incidentally, there has also been a proposal of a method using a statistical prediction model, as the method for predicting the energy consumption of each equipments in the facility containing the plurality of equipments. (See Japanese Patent Publication No. 2005.157829, for example.)

### DISCLOSURE OF THE INVENTION

However, the above-mentioned method using the statistical prediction model has not been usable when the settings or operating conditions of equipment is changed, or for the purpose of predicting energy consumption of equipment provided in a similar facility. This is because the statistical prediction model is the model effective only for a modeled facility or equipment, and only under a modeled condition (e.g., operation mode of the equipment or the setting value of the equipment).

On the other hand, the method using the heat balance model has difficulty in constructing a heat balance model having a high prediction accuracy of energy consumption.

Specifically, the construction of the highly accurate heat balance model requires consideration of various heat loads as heat loads acting on the facility or equipment, and thus requires identification of many parameters, as mentioned above. Moreover, highly accurate identification of many parameters requires a great deal of measurement data.

Here, a point of measurement needs to be provided for each of subareas, in order to obtain measurement data from each of the subareas. The inside of the facility; the outside of the facility, the boundary (e.g., an outer wall or a root between the inside and outside thereof, and the like are subdivided into the subareas. There is a need for providing a large number of measurement points, such as the measurement points of the temperature and humidity on the roof or the outer wall and the measurement points of the temperature and humidity in the facility, for example.

Therefore, taking feasibility into consideration, available measurement data is limited, and thus it is difficult to identify many parameters with high accuracy.

In addition, the COP of each equipments changes according to conditions, such as the temperature and humidity inside and outside the facility, the operation mode of the equipment, the setting value of the equipment, and the magnitude of process heat load. This makes it difficult to identify the COP of each equipments with high accuracy.

The present invention has been made to solve the above-mentioned problems. An object of the present invention is to provide: a modeling device and a modeling program capable of easily constructing a heat balance model for predicting energy consumption of equipment with high accuracy when there is a change in equipment or a change in equipment settings, or for predicting energy consumption of equipment provided in a similar facility with high accuracy; a simulation device and a simulation program for predicting energy consumption of equipment by using the heat balance model; and a method and system for using the heat balance model.

A feature of a first aspect according to the present invention is that a modeling device includes: a classification unit (a classification unit 120) configured to classify measurement data acquired in order to identify a parameter required to construct a heat balance model for a facility (a facility 10) containing a plurality of equipments (an air conditioner (including an outdoor unit 11 and an indoor unit 12), an air conditioner (including an outdoor unit 21 and an indoor unit 22), a condensing unit 31, a condensing unit 41, and the like), for each of classification conditions affecting the parameter; and an identification unit (an identification unit 130) configured to identify the parameter for each of the classification conditions, based on the measurement data classified for each of the classification conditions.

According to the feature, the identification unit identifies the parameter required to construct the heat balance model, based on the measurement data classified for each of classification conditions (that is, factors that cause parameter variations) affecting the parameter. Thereby, the identification unit can use a smaller number of measurement data items than hitherto to identity the parameter, while suppressing the parameter variations. Also, the number of parameters required to construct the heat balance model that predicts the energy consumption with high accuracy can become smaller than hitherto.

Even if the number of measurement data items or parameters is reduced, the above feature enables easy construction of a heat balance model that predicts, with high accuracy, energy consumption of equipment when there is a change in equipment or a change in equipment settings, or energy consumption of equipment provided in a similar facility.

One feature of the present invention is that, in the above-described feature of the present invention, the classification conditions are set in accordance with a facility factor including at least any one of temperature in the facility; humidity in the facility, temperature outside the facility, humidity outside the facility, and sensor information indicative of the opening and closing of an entrance door of the facility.

One feature of the present invention is that, in the above-described feature of the present invention, the classification conditions are set in accordance with a time factor including at least any one of time, day, month and season.

One feature of the present invention is that, in the above-described feature of the present invention, the classification conditions are set in accordance with a weather factor including at least any one of weather, precipitation and mean temperature.

One feature of the present invention is that, in the above-described feature of the present invention, the classification conditions are set in accordance with an equipment factor including at least any one of information as to whether or not the equipment is in operating condition, operating mode of the equipment, a temperature set for the equipment, an air flow set for the equipment, whether a thermo-condition for temperature control of the equipment is on or off, and sensor information acquired relative to the equipment. Incidentally, the information as to whether the thermo-condition is on or off indicates whether the function of controlling equipment output (e.g., cooling capability or heating capability) according to an ambient temperature around the equipment (e.g., the temperature in the facility) is on or off.

One feature of the present invention is that, in the above-described feature of the present invention, the parameter is any one of a proportional coefficient used to calculate an amount of conductive heat flowing into and out of the facility or an amount of radiation heat flowing into the facility, a coefficient used to calculate an amount of ventilation heat flowing into and out of the facility, and a coefficient representing the relationship between capabilities of the equipment and energy consumption of the equipment.

A feature of a second aspect according to the present invention is that a simulation device includes: an acquisition unit (an acquisition unit 220) configured to acquire a parameter for each of classification conditions affecting the parameter required to construct a heat balance model for a facility containing a plurality of equipments; an extraction unit (an extraction unit 230) configured to receive a simulation condition, and extract a parameter which matches the simulation condition, from the parameter acquired for each of the classification conditions by the acquisition unit; and a prediction unit (a prediction unit 240) configured to predict the energy consumption of the equipment, using the parameter extracted by the extraction unit, wherein the parameter is identified, based on measurement data classified for each of the classification conditions.

According to the feature, the parameter required to construct the heat balance model is identified, based on the measurement data classified for each of classification conditions affecting the parameter. Thereby, even if the number of parameters for the heat balance model is reduced, the parameter variations can be suppressed. Therefore, this feature can suppress deterioration in the accuracy of predicting energy consumption of the simulation device, while facilitating construction of the heat balance model.

A feature of a third aspect according to the present invention is that a modeling program which is run on a computer includes: a step A of classifying measurement data acquired in order to identify a parameter required to construct a heat balance model for a facility containing a plurality of equipments, for each of classification conditions affecting the parameter; and a step B of identifying the parameter for each of the classification conditions, based on the measurement data classified for each of the classification conditions.

A feature of a fourth aspect according to the present invention is that a simulation program which is run on a computer includes: a step C of acquiring a parameter for each of classification conditions affecting the parameter required to construct a heat balance model for a facility containing a plurality of equipments; a step D of receiving a simulation condition, and extracting a parameter which matches the simulation condition, from the parameter acquired for each of the classification conditions at the step C; and a step E of predicting the energy consumption of the equipment, using the parameter extracted at the step D, wherein the parameter is identified, based on measurement data classified for each of the classification conditions.

A feature of a fifth aspect according to the present invention is that a method for using a heat balance model includes: a step A of classifying measurement data acquired in order to identify a parameter required to construct the heat balance model for a facility containing a plurality of equipments, for each of classification conditions affecting the parameter; a step B of identifying the parameter for each of the classification conditions, based on the measurement data classified for each of the classification conditions; a step C of acquiring the parameter identified at the step B, for each of the classification conditions; a step D of receiving a simulation condition, and extracting a parameter which matches the simulation condition, from the parameter acquired for each of the classification conditions at the step C; and a step E of predicting energy consumption of the equipment, using the parameter extracted at the step D.

A feature of a sixth aspect according to the present invention is that a system for using a heat balance model includes: a classification unit configured to classify measurement data acquired in order to identify a parameter required to construct a heat balance model for a facility containing a plurality of equipments, for each of classification conditions affecting the parameter; an identification unit configured to identify the parameter for each of the classification conditions, based on the measurement data classified for each of the classification conditions; an acquisition unit configured to acquire the parameter identified by the identification unit, for each of the classification conditions; an extraction unit configured to receive a simulation condition, and extract a parameter which matches the simulation condition, from the parameter acquired for each of the classification conditions by the acquisition unit and a prediction unit configured to predict energy consumption of the equipment, using the parameter extracted by the extraction unit.

The present invention provides: a modeling device and a modeling program capable of easily constructing a heat balance model for predicting energy consumption of equipment with high accuracy when there is a change in equipment or a change in equipment settings, or for predicting energy consumption of equipment provided in a similar facility with high accuracy; a simulation device and a simulation program for predicting energy consumption of equipment by using the heat balance model; and a method and a system for using the heat balance model.

### BRIEF DESCRIPTION OF THE DRAWINGS

FIG. 1 is a diagram showing an example of a heat balance model according to a first embodiment of the present invention.

FIG. 2 is a block diagram showing the configuration of a modeling device 100 according to the first embodiment of the present invention.

FIG. 3 is a block diagram showing the configuration of a simulation device 200 according to the first embodiment of the present invention.

FIG. 4 is a table showing an example of classification conditions according to the first embodiment of the present invention.

FIG. 5 is a flowchart showing operation of the modeling device 100 according to the first embodiment of the present invention (Part 1).

FIG. 6 is a flowchart showing operation of the modeling device 100 according to the first embodiment of the present invention (Part 2).

FIG. 7 is a flowchart showing operation of the simulation device 200 according to the first embodiment of the present invention.

FIG. 8 is a table showing an example of a table according to the first embodiment of the present invention.

FIG. 9 is a table for explaining an example of the present invention.

FIG. 10 is a table for explaining an example of the present invention.

FIG. 11 is a table for explaining an example of the present invention.

FIG. 12 is a table for explaining an example of the present invention.

FIG. 13 is a table for explaining an example of the present invention.

FIG. 14 is a table for explaining an example of the present invention.

FIG. 15 is a table for explaining an example of the present invention.

FIG. 16 is a diagram showing an example of a heat balance model according to a second embodiment of the present invention.

FIG. 17 is a diagram showing an example of a heat balance model according to a third embodiment of the present invention.

FIG. 18 is a diagram showing an example of a heat balance model according to a fourth embodiment of the present invention.

FIG. 19 is a diagram showing an example of a heat balance model according to a fifth embodiment of the present invention.

FIG. 20 is a diagram showing an example of a heat balance model according to a sixth embodiment of the present invention.

FIG. 21 is a diagram showing an example of a heat balance model according to a seventh embodiment of the present invention.

FIG. 22 is a diagram showing an example of a heat balance model according to an eighth embodiment of the present invention.

FIG. 23 is a table for explaining an example of the present invention.

FIG. 24 is a table for explaining an example of the present invention.

FIG. 25 is a table for explaining an example of the present invention.

FIG. 26 is a table for explaining an example of the present invention.

### BEST MODE FOR CARRYING OUT THE INVENTION

Description will be given below with reference to the drawings with regard to modeling and simulation devices according to embodiments of the present invention. Incidentally, in the following description of the drawings, the same or similar parts are designated by the same or similar reference numerals.

It should be noted that the drawings are in schematic form and the ratio between dimensions or the like is different from the actual ratio. Therefore, it is to be understood that specific dimensions and the like are determined in view of the following description. Also, it is a matter of course that portions having a different relationship and ratio of respective dimensions are included in the mutual drawings.

### First Embodiment

### Outline of Heat Balance Model

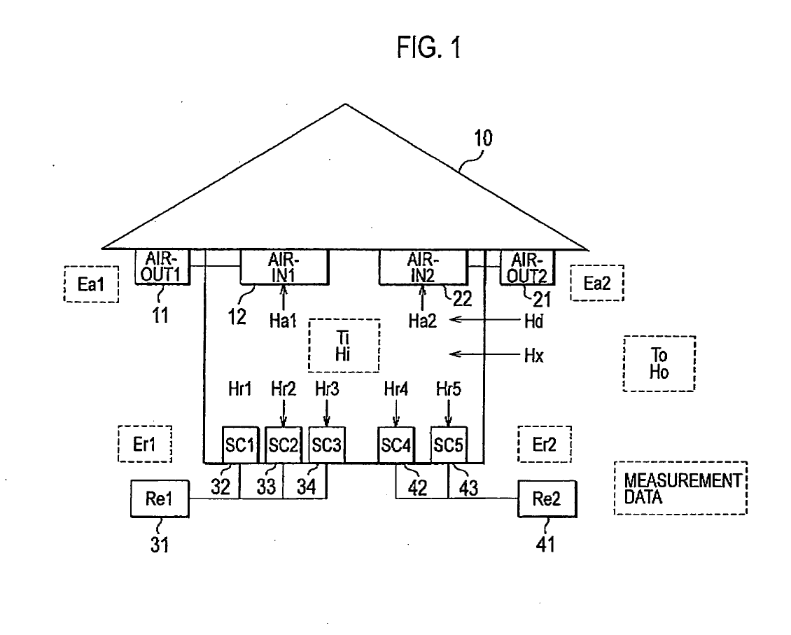

Description will be given below with reference to the drawings, with regard to an outline of a heat balance model according to a first embodiment of the present invention. FIG. 1 is a diagram showing the outline of the heat balance model according to the first embodiment of the present invention.

As shown in FIG. 1, a facility 10 contains a plurality of equipments (e.g., an outdoor unit 11, an indoor unit 12, an outdoor unit 21, an indoor unit 22, a condensing unit 31, showcases 32 to 34, a condensing unit 41, and showcases 42 and 43).

The facility 10 contains a plurality of equipments that affect heat balance in the facility 10, and is, for example, a convenience store, a supermarket, or the like.

An air conditioner (including the outdoor unit 11 and the indoor unit 12) is the air conditioner that controls temperature or humidity in the facility 10. Likewise, an air conditioner (including the outdoor unit 21 and the indoor unit 22) is the air conditioner that controls the temperature or humidity in the facility 10.

The condensing unit 31 is the equipment for cooling the showcases 32 to 34. Also, the showcases 32 to 84 include an open showcase not provided with a door or the like so that customers are free to take articles out of the showcase, and a closed showcase provided with the door in order to increase cooling efficiency. Incidentally, the open showcase has an air curtain rather than the door in order to increase the cooling efficiency. Also, the showcases 32 to 34 may be freezing showcases that freeze the articles, or may be refrigerating showcases that refrigerate the articles.

The condensing unit 41 is, as in the case of the condensing unit 31, the equipment for cooling the showcases 42 and 43. Also, the showcases 42 and 43 include the open showcase and the closed showcase. Incidentally, the showcases 42 and 43 may be the freezing showcases or the refrigerating showcases.

Here, temperature (Ti) in the facility, humidity (Hi) in the facility; temperature (To) outside the facility, humidity (Ho) outside the facility; power consumption (Ea1) of the outdoor unit 11, power consumption (Ea2) of the outdoor unit 21, power consumption (Er1) of the condensing unit 31, and power consumption (Er2) of the condensing unit 41 are measurement data acquired in order to identify parameters required to construct the heat balance model.

Also, the parameters required to construct the heat balance model include: a coefficient (e.g., KA), which is a proportional coefficient used to calculate the amount of conductive heat flowing into and out of the facility 10 or the amount of radiation heat flowing into the facility 10, and which is multiplied by a difference between the temperature in the facility 10 and the temperature outside the facility 10 to obtain a value representing the amount of conductive heat or the amount of radiation heat; a coefficient (e.g., Vx), which is the coefficient used to calculate the amount of ventilation heat flowing into and out of the facility 10, and which is multiplied by a difference between enthalpy in the facility 10 and enthalpy outside the facility 10 to obtain a value representing the amount of ventilation heat; and a coefficient (e.g., COP), which is the coefficient representing the relationship between capabilities (e.g., heating/cooling capabilities) of the equipment provided in the facility 10 and energy consumption of the equipment, and which is a value obtained by dividing the capabilities of the equipment by the energy consumption of the equipment.

In the first embodiment, the parameters include a coefficient of heat transfer (KA [kJ/° C./s]) between the inside and outside of the facility 10, a coefficient of ventilation (Vx [kg/s]) between the inside and outside of the facility 10, a coefficient of performance (COPa1) of the outdoor unit 11, a coefficient of performance (COPa2) of the outdoor unit 21, a coefficient of performance (COPr1) of the condensing unit 31, and a coefficient of performance (COPr2) of the condensing unit 41.

Here, conductive heat load (Hd [kJ/s]) applied to the facility 10 is found by the following Equation (1). Here, the conductive heat load is set to be the heat load considering radiation heat load applied to the facility 10 as well. In other words, the coefficient of heat transfer (KA) is the coefficient considering the conductive heat load and the radiation heat load.

Hd=KA(To−Ti) (1)

Ventilation heat load (Hx [kJ/s]) on the facility 10 is found by the following Equation (2).

Hx=Vx{H(To,Ho)−H(Ti,Hi)} (2)

Incidentally, H(T,H) represents enthalpy ([kJ/kg]) of air at temperature T and humidity H.

Heat loads (Hr [kJ/s]) applied to the showcases are found by the following Equations (3) to (7), respectively. Specifically, the heat load applied to the showcase 32 is found by the following Equation (3).

Hr1=Vr1{H(Ti,Hi)−H(Tt,Ht)} (3)

The heat load applied to the showcase 33 is found by the following Equation (4).

Hr2=Yr2{H(Ti,Hi)−H(Tt,Ht)} (4)

The heat load applied to the showcase 34 is found by the following Equation (5).

Hr3=Vr3{H(Ti,Hi)−H(Tt,Ht)} (5)

The heat load applied to the showcase 42 is found by the following Equation (6).

Hr4=Vr4{H(Ti,Hi)−H(Tt,Ht)} (6)

The heat load applied to the showcase 43 is found by the following Equation (7).

Hr5=Vr5{H(Ti,Hi)−H(Tt,Ht)} (7)

Here, H(Tt,Ht) represents enthalpy of cooling air ejected by the showcases, and, for example, H(0° C., 100%) is set if the showcase is the refrigerating showcase, or H(−20° C., 100%) is set if the showcase is the freezing showcase. Also, Vr1 to Vr5 represent the amounts of substitution air [kg/s] in the showcases, respectively, and are known values.

As represented by Equations (3) to (7), the temperature (Ti) in the facility and the humidity (Hi) in the facility can be measured to calculate the heat loads applied to the showcases.

The power consumption [kW] of the condensing unit 31 is found by the following Equation (8).

Er1=(Hr1+Hr2+Hr3)/COPr1 (8)

The power consumption [kW] of the condensing unit 41 is found by the following Equation (9).

Er2=(Hr4+Hr5)/COPr2 (9)

As represented by Equations (8) and (9), the power consumption of the condensing units can be measured to calculate the coefficients of performance of the condensing units. In other words, the temperature (Ti) in the facility, the humidity (Hi) in the facility and the power consumption of the condensing units can be measured to calculate the coefficients of performance of the condensing units.

Heat load applied to the air conditioners (or the indoor units 12 and 22) is found by the following Equation (10).

Ha1+Ha2=Hd+Hx−(Hr1+Hr2+Hr3+Hr4+Hr5) (10)

The power consumption [kW] of the outdoor unit 11 is found by the following Equation (11).

Ea1=Ha1/COPa1 (11)

The power consumption [kW] of the outdoor unit 21 is found by the following Equation (12).

Ea2=Ha2/COPa2 (12)

Here, combining Equations (10) to (12) into an equation not using the heat load (Ha1 and Ha2) leads to Equation (13).

Ea1*COPa1+Ea2*COPa2=Hd+Hx−(Hr1+Hr2+Hr3+Hr4+Hr5) (13)

Here, Equation (13) contains four parameters, namely, COPa1, COPa2, KA and Vx, and thus, at least four sets of measurement data can be prepared to identify the parameters.

The parameters identified in this manner can be used to construct the heat balance model, and also, the heat balance model can be used to predict the power consumption of each equipments.

Incidentally, the condensing units 31 and 41 have connections to the showcases; however, it is to be understood that they are not limited to this and may have a connection to a refrigerator or a freezer. The same procedure as that of the showcase can be used to calculate heat load applied to the refrigerator or the freezer.

### (Configuration of Modeling Device)

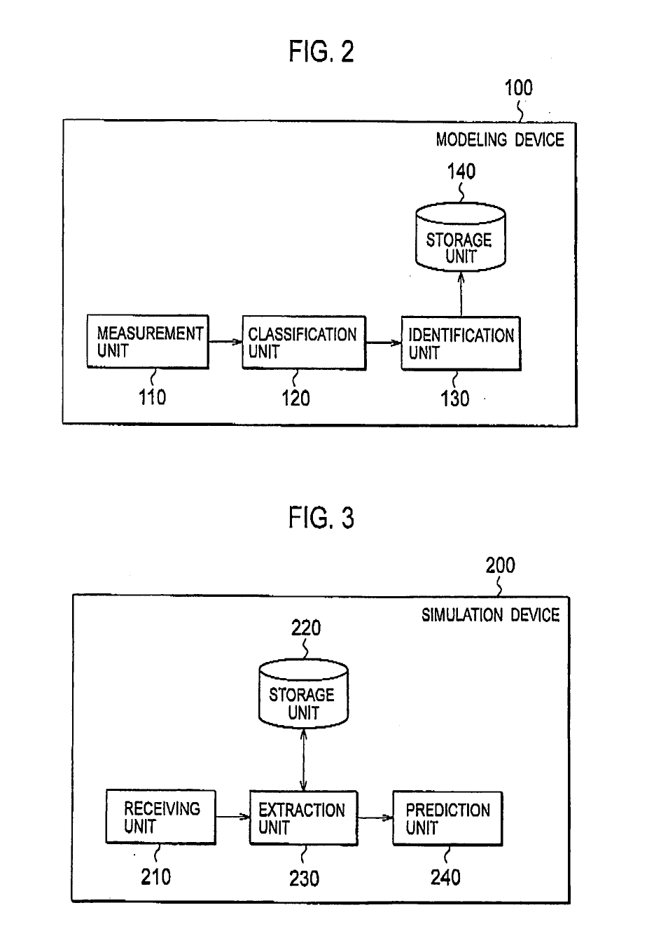

Description will be given below with reference to the drawing, with regard to the configuration of the modeling device according to the first embodiment of the present invention. FIG. 2 is a block diagram showing the configuration of a modeling device 100 according to the first embodiment of the present invention.

As shown in FIG. 2, the modeling device 100 includes a measurement unit 110, a classification unit 120, an identification unit 130, and a storage unit 140.

The measurement unit 110 is a sensor or the like that acquires the measurement data in order to identify the parameters required to construct the heat balance model. Incidentally, the measurement data includes, for example, the temperature (Ti) in the facility, the humidity (Hi) in the facility, the temperature (To) outside the facility, the humidity (Ho) outside the facility, the power consumption (Ea1) of the outdoor unit 11, the power consumption (Ea2) of the outdoor unit 21, the power consumption (Er1) of the condensing unit 31, and the power consumption (Er2) of the condensing unit 41, as mentioned above.

The classification unit 120 classifies the measurement data acquired by the measurement unit 110, for each of classification conditions affecting the parameters.

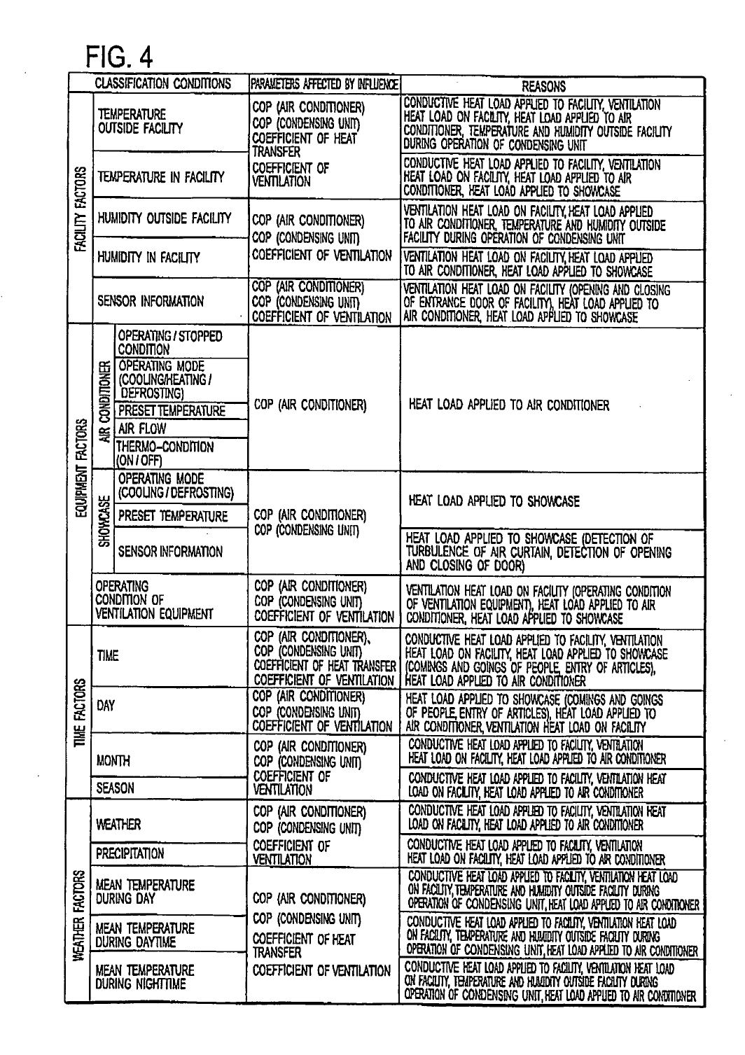

Here, the classification conditions are conditions set in accordance with facility factors, equipment factors, time factors and weather factors. Also, it is preferable that the classification conditions vary according to the parameters. Incidentally, description will be given later with regard to details of the classification conditions. (See FIG. 4.)

The identification unit 130 identifies the parameters required to construct the heat balance model, for each classification condition, based on the measurement data classified by the classification unit 120. Specifically, the identification unit 130 substitutes the measurement data into the heat balance model represented by Equations (1) to (13) thereby to identify the parameters for each classification condition. Incidentally, as mentioned above, the parameters include, for example, the coefficient of heat transfer (KA [kJ/° C./s]) between the inside and outside of the facility 10, the coefficient of ventilation (Vx [kg/s]) between the inside and outside of the facility 10, the coefficient of performance (COPa1) of the outdoor unit 11, the coefficient of performance (COPa2) of the outdoor unit 21, the coefficient of performance (COPr1) of the condensing unit 31, and the coefficient of performance (COPr2) of the condensing unit 41.

The storage unit 140 stores the parameters identified by the identification unit 130, in correspondence with the classification conditions referred to at the time of identification of the parameters.

### (Configuration of Simulation Device)

Description will be given below with reference to the drawing, with regard to the configuration of the simulation device according to the first embodiment of the present invention. FIG. 3 is a block diagram showing the configuration of a simulation device 200 according to the first embodiment of the present invention.

As shown in FIG. 3, the simulation device 200 includes a receiving unit 210, a storage unit 220, an extraction unit 230, and a prediction unit 240.

The receiving unit 210 receives simulation conditions entered by a user or the like. Here, the simulation conditions are the same conditions as the classification conditions and refer to such conditions as are set in accordance with the facility factors, the equipment factors, the time factors and the weather factors.

Also, to perform simulation of introduction of new equipment, the receiving unit 210 receives the COP of newly introduced equipment as a simulation condition. On the other hand, to perform simulation for a new facility, the receiving unit 210 receives the coefficient of heat transfer (KA) and the coefficient of ventilation (Vx) for the new facility as simulation conditions.

The storage unit 220 stores the parameters in correspondence with the classification conditions, as is the case with the storage unit 140. Here, the parameters stored in the storage unit 220 are the parameters identified based on the measurement data classified for each classification condition corresponding to the parameters.

The extraction unit 230 specifies the classification condition which matches the simulation condition received by the receiving unit 210, and extracts the parameter corresponding to the specified classification condition from the storage unit 220.

Also, to perform simulation of introduction of new equipment, the extraction unit 230 overwrites the COP of equipment to be replaced, with the COP of the newly introduced equipment. On the other hand, to perform simulation for a new facility, the extraction unit 230 overwrites the coefficient of heat transfer (KA) and the coefficient of ventilation (Vx) extracted from the storage unit 220 with the coefficient of heat transfer (KA) and the coefficient of ventilation (Vx) for the new facility.

The prediction unit 240 substitutes the parameter extracted by the extraction unit 230 and the parameter overwritten by the extraction unit 230 into the heat balance model thereby to calculate the power consumption of the equipment contained in the facility.

### (Example of Classification Conditions)

Description will be given below with reference to the drawing, with regard to an example of classification conditions according to the first embodiment of the present invention. FIG. 4 is a table showing an example of classification conditions according to the first embodiment of the present invention.

As shown in FIG. 4, the classification conditions include facility factors, equipment factors, time factors, and weather factors.

The facility factors are subdivided into the temperature outside the facility, the humidity outside the facility, the temperature in the facility, the humidity in the facility, and sensor information. The equipment factors on the air conditioner are subdivided into information on whether or not the air conditioner is in operation, operation mode of the air conditioner, a preset temperature set for the air conditioner, the air flow of the air conditioner, and information on whether the thermo condition of the air conditioner is on or off. The equipment factors on the showcase are subdivided into operation mode of the showcase (cooling/defrosting mode), a preset temperature of the showcase, and sensor information. The equipment factors on ventilation equipment are operation mode of the ventilation equipment. The time factors are subdivided into time, the day of the week, the month, and the season. The weather factors are subdivided into weather, precipitation, the mean temperature per day, the mean temperature in the daytime, and the mean temperature in the nighttime.

Incidentally, whether the thermo condition is on or off indicates the function of controlling output of the equipment (e.g., cooling capacity and heating capacity) is on or off according to the ambient temperature around the equipment (e.g., the temperature in the facility).

Description will be given below in order with reference to the drawing, with regard to the classification conditions that affect the parameters, taking as an example of parameters the coefficient of heat transfer (KA), the coefficient of ventilation (Vx), the COP (of the air conditioner) and the COP (of the condensing unit).

### (1) Regarding the Coefficient of Heat Transfer (KA)

The conductive heat load applied to the facility 10 depends on the temperature outside the facility and the temperature in the facility as represented by Equation (1). Thus, among the facility factors, the temperature outside the facility and the temperature in the facility are the classification conditions that affect the coefficient of heat transfer (KA).

The conductive heat load applied to the facility 10 depends on sunlight radiation heat. Thus, among the time factors, the time having correlation to the sunlight radiation heat is the classification condition that affects the coefficient of heat transfer (KA). Also, the conductive heat load applied to the facility 10 depends on the temperature outside the facility. Thus, among the time factors, the month and season having correlation to the temperature outside the facility are the classification conditions that affect the coefficient of heat transfer (KA).

The conductive heat load applied to the facility 10 depends on the sunlight radiation heat. Thus, among the weather factors, the weather (e.g., sunny, rainy, or cloudy) and precipitation having correlation to the sunlight radiation heat are the classification conditions that affect the coefficient of heat transfer (KA). Also, the conductive heat load applied to the facility 10 depends on the temperature outside the facility. Thus, among the weather factors, the mean temperature during a clay, the mean temperature during the daytime and the mean temperature during the nighttime having correlation to the temperature outside the facility are the classification conditions that affect the coefficient of heat transfer (KA).

### (2) Regarding the Coefficient of Ventilation (Vx)

The ventilation heat load applied to the facility 10 depends on the enthalpy of the air outside the facility 10 and the enthalpy of the air in the facility 10 as represented by Equation (2). Thus, among the facility factors, the temperature outside the facility, the humidity outside the facility, the temperature in the facility and the humidity in the facility are the classification conditions that affect the coefficient of ventilation (Vx). Also, the ventilation heat load applied to the facility 10 depends on whether or not the comings and goings of customers into and out of the facility 10 are frequent. Thus, among the facility factors, sensor information indicative of the opening and closing of an entrance door of the facility is the classification condition that affects the coefficient of ventilation (Vx).

The ventilation heat load applied to the facility 10 depends on whether or not the comings and goings of customers are frequent, and whether or not articles are being brought in. Thus, among the time factors, the time and the day having correlation to the incoming and outgoing customers or articles are the classification conditions that affect the coefficient of ventilation (Vx). Also, the ventilation heat load applied to the facility 10 depends on the enthalpy of the air outside the facility. Thus, among the time factors, the month and the season having correlation to the enthalpy of the air outside the facility are the classification conditions that affect the coefficient of ventilation (Vx).

The ventilation heat load applied to the facility 10 depends on the enthalpy of the air outside the facility. Thus, the weather factor having correlation to the enthalpy of the air outside the facility is the classification condition that affects the coefficient of ventilation (Vx).

The ventilation heat load applied to the facility 10 is affected by the operating condition of ventilation equipment (e.g., a ventilation fan or a desiccant air conditioning system). Thus, among the equipment factors, the operating condition of the ventilation equipment is the classification condition that affects the coefficient of ventilation (Vx).

### (3) Regarding the COP (of the Air Conditioner)

The heat load applied to the air conditioner depends on the conductive heat load applied to the facility 10 and the ventilation heat load applied to the facility 10 as represented by Equation (10). Thus, the factors that affect the coefficient of heat transfer (KA) and the coefficient of ventilation (Vx) are the classification conditions that affect the COP (of the air conditioner). Likewise, the heat load applied to the air conditioner depends on the heat load applied to different equipment (e.g., the showcase). Thus, the factors that affect the heat load applied to the different equipment (e.g., the showcase) are the classification conditions that affect the COP (of the air conditioner). Incidentally, description will be given later with regard to the factors that affect the heat load applied to the different equipment (e.g., the showcase). (See the COP (of the condensing unit).)

In addition to these, the following conditions may be included in the classification conditions that affect the heat load applied to the air conditioner.

The heat load applied to the air conditioner depends on the equipment factors related to the air conditioner. Thus, the equipment factors related to the air conditioner are the classification conditions that affect the COP (of the air conditioner).

The heat load applied to the air conditioner depends on the comings and goings of customers. Thus, among the time factors, the time and the day having correlation to the comings and goings of customers are the classification conditions that affect the COP (of the air conditioner). Also, the heat load applied to the air conditioner depends on the operating mode of the air conditioner. Thus, among the time factors, the month or the season having correlation to the operating mode of the air conditioner is the classification condition that affects the COP (of the air conditioner).

The heat load applied to the air conditioner is affected by the sunlight radiation heat. Thus, among the weather factors, the weather (e.g., sunny, rainy, or cloudy) and precipitation having correlation to the sunlight radiation heat are the classification conditions that affect the COP (of the air conditioner). Also, the heat load applied to the air conditioner depends on the temperature outside the facility. Thus, among the weather factors, the mean temperature during a day, the mean temperature during the daytime and the mean temperature during the nighttime are the classification conditions that affect the COP (of the air conditioner).

Incidentally, the COP (of the air conditioner) has a value that varies according to the process heat load of the air conditioner.

### (4) Regarding the COP (of the Condensing Unit)

The heat load applied to the showcase depends on the enthalpy of the air in the facility as represented by Equations (3) to (7). Thus, among the facility factors, the temperature in the facility and the humidity in the facility are the classification conditions that affect the COP (of the condensing unit). Also, the heat load applied to the showcase depends on whether or not the comings and goings of customers into and out of the facility 10 are frequent. Thus, among the facility factors, the sensor information indicative of the opening and closing of the entrance door of the facility is the classification condition that affects the COP (of the condensing unit). Further, the COP (of the condensing unit) depends on the temperature and humidity outside the facility during operation of the condensing unit. Thus, among the facility factors, the temperature and humidity outside the facility is the classification condition that affects the COP (of the condensing unit).

The heat load applied to the showcase depends on whether the showcase is in cooling operation or in defrosting operation. Thus, among the equipment factors, the operating mode is the classification condition that affects the COP (of the condensing unit). Also, the heat load applied to the showcase depends on a temperature set for the showcase. Thus, among the equipment factors, the preset temperature is the classification condition that affects the COP (of the condensing unit). Incidentally, the temperature set for the showcase is available based on showcase maintenance records (e.g., the temperature) or the like.

If the showcase is the open showcase, the heat load applied to the open showcase depends on turbulence of the air curtain. Thus, among the equipment factors, sensor information indicative of the detected result of the turbulence of the air curtain is the classification condition that affects the COP (of the condensing unit). Further, if the showcase is the closed showcase, the heat load applied to the closed showcase is influenced by the opening and closing of the door. Thus, among the equipment factors, sensor information indicative of the detected result of the opening and closing of the door is the classification condition that affects the COP (of the condensing unit).

The heat load applied to the showcase is affected by the operating condition of the ventilation equipment. Thus, among the equipment factors, the operating condition of the ventilation equipment is the classification condition that affects the COP (of the condensing unit).

The heat load applied to the showcase depends on the turbulence of the air curtain caused by the incoming and outgoing customers or articles, or the opening and closing of the door caused by the incoming and outgoing customers or articles. Thus, among the time factors, the time and the day having correlation to the turbulence of the air curtain or the opening and closing of the door are the classification conditions that affect the COP (of the condensing unit). Also, the heat load applied to the showcase depends on the incoming articles. Thus, among the time factors, the time and the day having correlation to the incoming articles (e.g., a time slot, the day, the amount of incoming articles, or the like) are the classification conditions that affect the COP (of the condensing unit).

Incidentally, the time and the day that affect the COP (of the condensing unit) are determined based on the results of questionnaires as to the date and time when customers use the facility 10 (e.g., the time slot or the day), taking into account the comings and goings of customers. Also, the time and the day that affect the COP (of the condensing unit) may be determined based on records on operation for bringing in articles (e.g., the time slot or the day), taking into account the incoming articles.

Incidentally, the classification conditions that affect the COP (of the condensing unit) may be determined, taking into account the amount of incoming articles, and the amount of incoming articles is obtained based on the records on the operation for bringing in articles.

The COP (of the condensing unit) depends on the temperature and humidity outside the facility during the operation of the condensing unit. Thus, among the weather factors, the mean temperature during a day, the mean temperature during the daytime and the mean temperature during the nighttime are the classification conditions that affect the COP (of the condensing unit).

Incidentally, the COP (of the condensing unit) has a value that varies according to the process heat load of the showcase or the condensing unit.

### (Operation of Modeling Device)

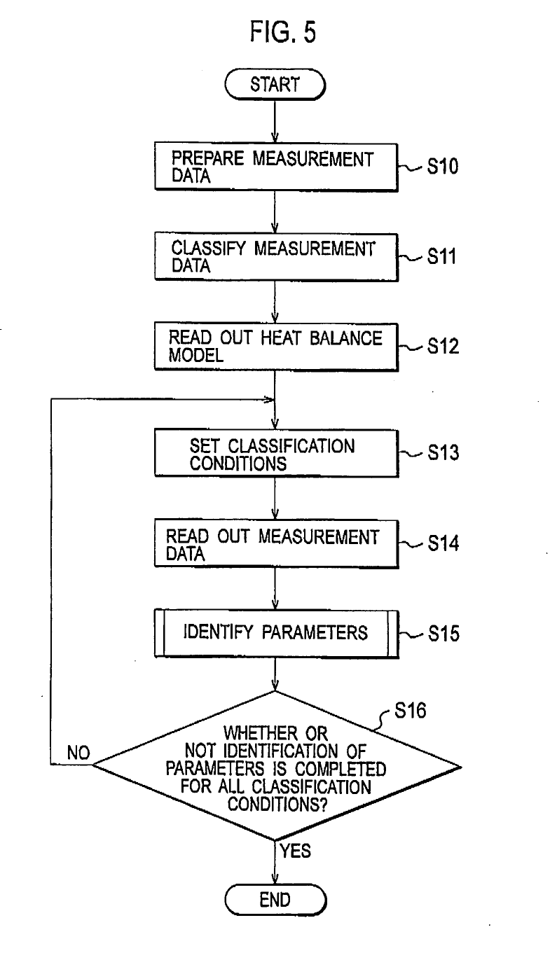

Description will be given below with reference to the drawing, with regard to the operation of the modeling device according to the first embodiment of the present invention. FIG. 5 is a flowchart showing the operation of the modeling device 100 according to the first embodiment of the present invention.

As shown in FIG. 5, at step 10, the modeling device 100 acquires measurement data over a predetermined period of time. Also, the modeling device 100 stores conditions for which the measurement data is acquired (that is, facility factors, equipment factors, time factors and weather factors), in conjunction with the measurement data.

At step 11, the modeling device 100 classifies the measurement data acquired at step 10, for each of the classification conditions affecting the parameters.

At step 12, the modeling device 100 prepares the heat balance model (represented by Equations (1) to (13)).

At step 13, the modeling device 100 sets the conditions that affect the parameters, in order to identify the parameters.

At step 14, the modeling device 100 reads out the measurement data classified as the classification conditions set at step 13.

At step 15, the modeling device 100 substitutes the measurement data read out at step 14 into the heat balance model read out at step 12 thereby to identify the parameters such as the coefficient of heat transfer (KA), the coefficient of ventilation (Vx), and the COP of the equipment.

At step 16, the modeling device 100 determines whether or not the identification of the parameters is completed for all classification conditions. Also, if the identification of the parameters is completed for all classification conditions, the modeling device 100 brings a series of processes to an end. If the identification of the parameters is not completed for all classification conditions, the modeling device 100 returns to step 13.

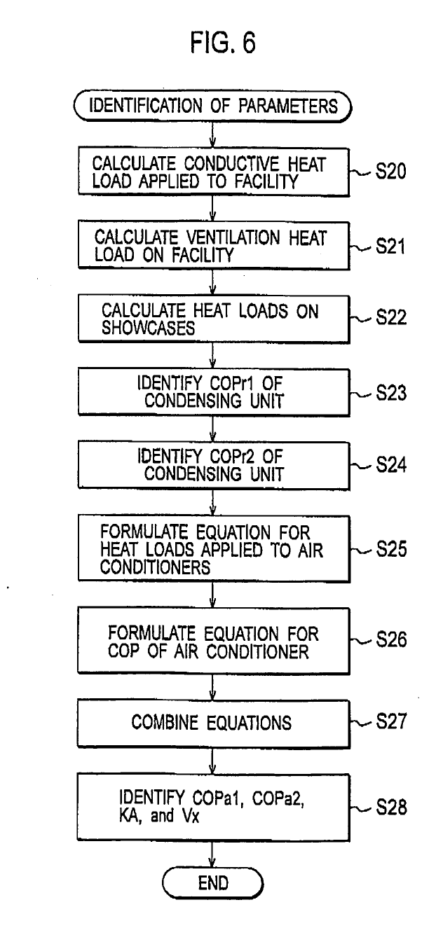

Then, description will be given below with reference to the drawing, with regard to the above-mentioned identification process for the parameters (step 15). FIG. 6 is a flowchart showing the identification process for the parameters according to the first embodiment of the present invention.

As shown in FIG. 6, at step 20, the modeling device 100 calculates the conductive heat load (Hd) applied to the facility 10, in accordance with the above Equation (1).

At step 21, the modeling device 100 calculates the ventilation heat load (Hx) on the facility 10, in accordance with the above Equation (2).

At step 22, the modeling device 100 calculates the heat loads (Hr1 to Hr5) on the showcases, in accordance with the above Equations (3) to (7).

At step 23, the modeling device 100 identifies the COPr1 of the condensing unit 31, in accordance with the above Equation (8), using the heat loads (Hr1 to Hr3) calculated at step 22 and the power consumption of the condensing unit 31.

At step 24, the modeling device 100 identifies the COPr2 of the condensing unit 41, in accordance with the above Equation (9), using the heat loads (Hr4 and Hr5) calculated at step 22 and the power consumption of the condensing unit 41.

At step 25, the modeling device 100 formulates the above Equation (10) for the heat loads (Ha1 and Ha2) applied to the air conditioners (or the indoor units 12 and 22).

At step 26, the modeling device 100 formulates the above Equation (11) for the COPa1 of the air conditioner (or the outdoor unit 11). Also, the modeling device 100 formulates the above Equation (12) for the COPa2 of the air conditioner (or the outdoor unit 21).

At step 27, the modeling device 100 combines the equations formulated at steps 25 and 26 thereby to formulate the above Equation (13). Here, the modeling device 100 uses at least four sets of measurement data to formulate at least four Equations (13).

At step 28, the modeling device 100 solves the simultaneous equations formulated at step 27 thereby to identify COPa1, COPa2, KA, and Vx.

In this manner, the parameters (COPr1, COPr2, COPa1, COPa2, KA and Vx) required to construct the heat balance model are identified.

### (Operation of Simulation Device)

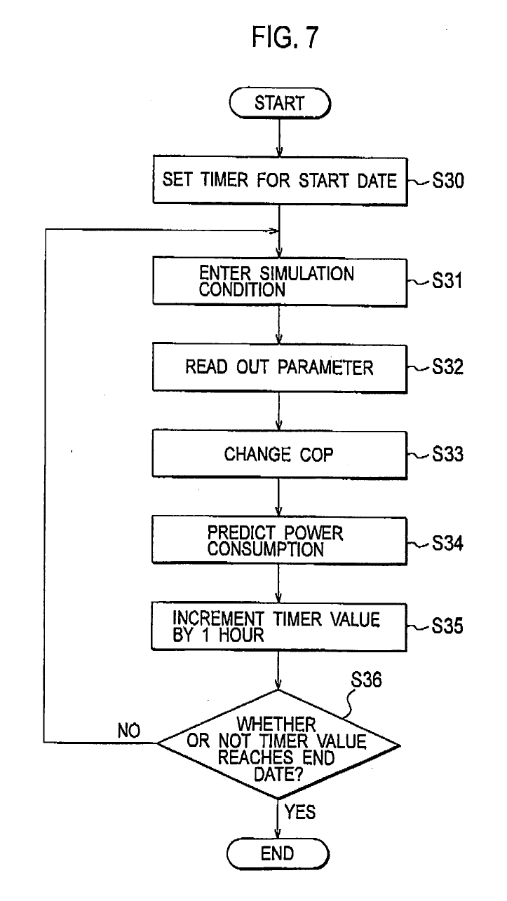

Description will be given below with reference to the drawing, with regard to the operation of the simulation device according to the first embodiment of the present invention. FIG. 7 is a flowchart showing the operation of the simulation device 200 according to the first embodiment of the present invention.

As shown in FIG. 7, at step 30, the simulation device 200 sets a timer for the start date of simulation.

At step 31, the simulation device 200 receives a simulation condition.

At step 32, the simulation device 200 reads out a classification condition which matches the simulation condition received at step 31, and also reads out a parameter in correspondence with the specified classification condition.

At step 33, the simulation device 200 changes parameters according to the purpose for which simulation is performed. Specifically, to perform simulation of introduction of new equipment, the simulation device 200 replaces the COP read out at step 32 with the COP of the equipment newly introduced. On the other hand, to perform simulation for a new facility, the simulation device 200 replaces the coefficient of heat transfer (KA) and the coefficient of ventilation (Vx) read out at step 32 with the coefficient of heat transfer (KA) and the coefficient of ventilation (Vx) for the new facility.

At step 34, the simulation device 200 predicts the power consumption of each equipments, based on the parameters read out at step 32 and the parameters changed at step 33.

Specifically, the simulation device 200 substitutes the coefficient of heat transfer (KA), the coefficient of ventilation (Vx), the COP (of the air conditioners), the COP (of the condensing units), the temperature (To) and humidity (Ho) outside the facility, and the temperature (Ti) and humidity (Hi) in the facility into the heat balance model represented by Equations (1) to (12) thereby to calculate the power consumption of each equipments, on an hourly basis. Incidentally, the simulation device 200 calculates the power consumption during a period between the start date and the end date by calculating the sum of the power consumption calculated on an hourly basis.

At step 35, the simulation device 200 increments the timer value by one hour.

At step 36, the simulation device 200 determines whether or not the timer value reaches the end date and time. Also, if the timer value reaches the end date and time, the simulation device 200 brings a series of processes to an end. If the timer value does not reach the end date and time, the simulation device 200 returns to step 31.

Incidentally, in the first embodiment, the power consumption of each equipments is calculated on an hourly basis; however, it is a matter of course that the interval between calculations is not limited to this and may be changed according to the purpose for which simulation is performed, or the like.

### (Example of Table Stored in Modeling Device)

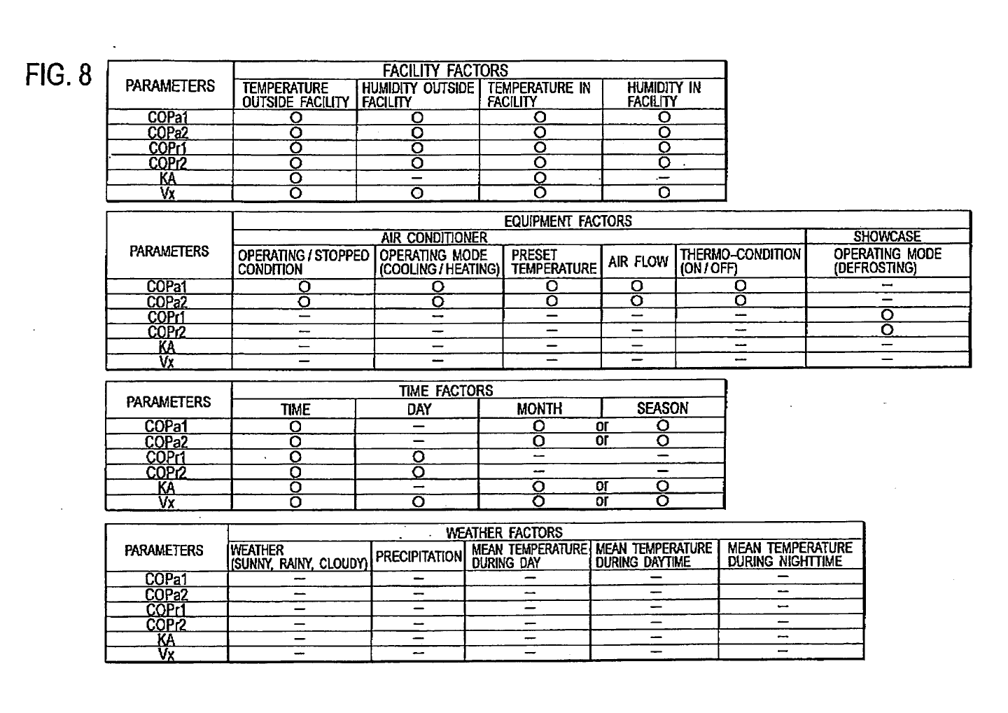

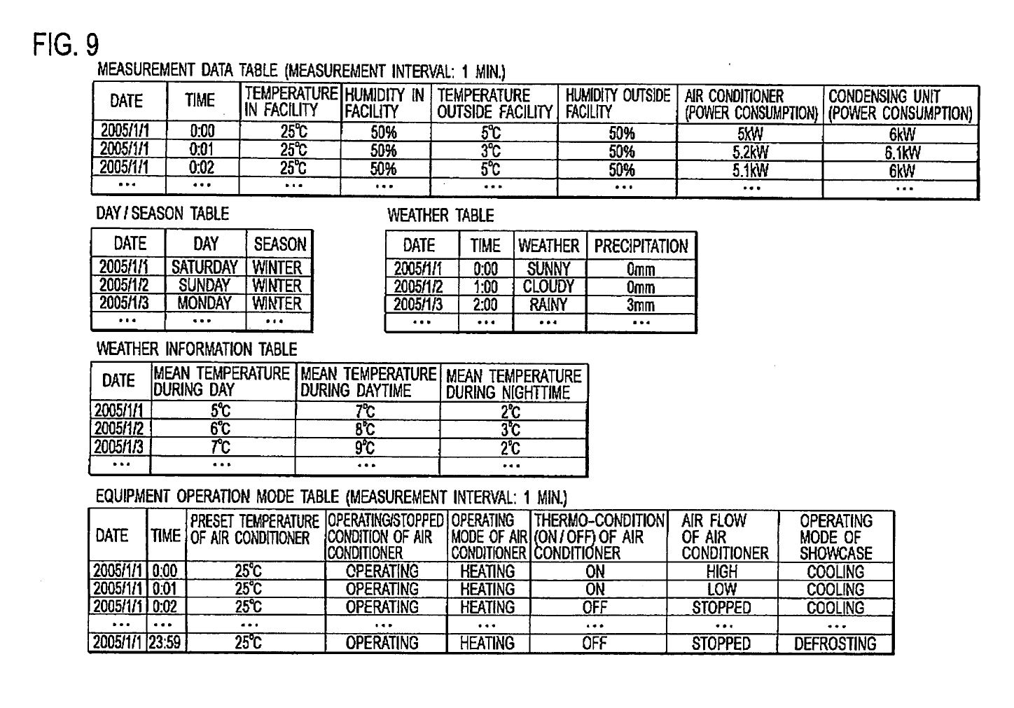

Description will be given below with reference to the drawing, with regard to an example of a table stored in the storage unit 140 of the modeling device 100. FIG. 8 is a table showing an example of the table stored in the storage unit 140 according to the first embodiment of the present invention.

As shown in FIG. 8, the table stored in the storage unit 140 is configured of the types of parameters, and the classification conditions referred to at the time of classification of the parameters. Also, in FIG. 8, the classification conditions referred to at the time of classification of the parameters are indicated by “o,” and the classification conditions not referred to at the time of classification of the parameters are indicated by “-.”

For example, as for the facility factors, all of the facility factors are referred to for the classification of COPa1, COPa2, COPr1, COPr2, KA and Vx. On the other hand, as for the equipment factors, only the equipment factors related to the air conditioners are referred to for the classification of COPa1 and COPa2, while only the equipment factors related to the showcases are referred to for the classification of COPr1 and COPr2.

Incidentally, it is a matter of course that, for a parameter classification method shown in FIG. 8, the table shown in FIG. 8 is illustrative only, and the classification conditions referred to for the classification of the parameters may be appropriately changed according to the type of the facility 10 (e.g., a supermarket or a convenience store) or the purpose for which the heat balance model is constructed. In other words, the classification conditions referred to for the classification of the parameters may be selected from among the classification conditions shown in FIG. 4, according to the type of the facility 10 or the purpose for which the heat balance model is constructed.

### (Functions and Advantageous Effects)

According to the modeling device 100 in the first embodiment of the present invention, the identification unit 130 identifies the parameter required to construct the heat balance model, based on the measurement data classified for each of classification conditions (that is, factors that cause parameter variations) affecting the parameter. Thereby, the identification unit 130 can use a smaller number of measurement data items than hitherto to identify the parameter, while suppressing the parameter variations. Also, the number of parameters required to construct the heat balance model that predicts the energy consumption with high accuracy can become smaller than hitherto.

Even if the number of measurement data items or parameters is reduced, the modeling device 100 enables easy construction of a heat balance model that predicts, with high accuracy; energy consumption of equipment when there is a change in equipment or a change in equipment settings, or energy consumption of equipment provided in a similar facility.

Also, according to the simulation device 200 in the first embodiment of the present invention, the parameter stored in the storage unit 220 is identified, based on the measurement data classified for each of the classification conditions affecting the parameter. Thereby, even if the number of parameters for the heat balance model is reduced so that a smaller number of measurement data items than hitherto is used to identify the parameter, the parameter variations can be suppressed. Therefore, the simulation device 200 can suppress deterioration in the accuracy of predicting power consumption of the simulation device 200, while facilitating construction of the heat balance model.

### EXAMPLES

Description will be given below with reference to the drawings, with regard to examples of the present invention. Specifically, description of examples of various tables stored in the modeling device 100, description of an example of parameter identification, and description of an example of the concept of a method for selecting classification conditions according to the type of the facility 10 will be given in this order. Incidentally, it should be noted that the following examples are illustrative only, and the present invention is not limited to these examples.

### (Example of Table)

FIG. 9 is a table showing an example of a table according to an example of the present invention. As shown in FIG. 9, the modeling device 100 stores a measurement data table, a day/season table, a weather table, a weather information table, an equipment operation mode table, and the like.

The measurement data table is the table containing the measurement data (e.g., the temperature and humidity in the facility, the temperature and humidity outside the facility, and the power consumption of each equipments) acquired by the above-mentioned measurement unit 110, in correspondence with the date and time. Incidentally, the measurement data is acquired, for example, at intervals of one minute.

The day/season table is the table containing the day and the season in correspondence with the date. Incidentally, it is preferable that the day/season table be prestored in the modeling device 100.

The weather table is the table containing the time, the weather, the precipitation and the like in correspondence with the date. Incidentally, the weather table is created based on meteorological data issued by the Meteorological Agency, or the like.

The weather information table is the table containing the mean temperature during a day, the mean temperature during the daytime and the mean temperature during the nighttime in correspondence with the date. Incidentally, the weather information table is created based on meteorological data issued by the Meteorological Agency, or the like, as in the case of the weather table.

The equipment operation mode table is the table containing the operation condition of each equipments (the air conditioner: the preset temperature, operating/stopped condition, operating mode, information on whether the thermo-condition is on or off, the air flow, or the like; the showcase: operating mode, or the like) in correspondence with the date and time. Incidentally, the operation condition of each equipments may be acquired as equipment operation information directly from the equipment, or may be acquired according to maintenance records on each equipments.

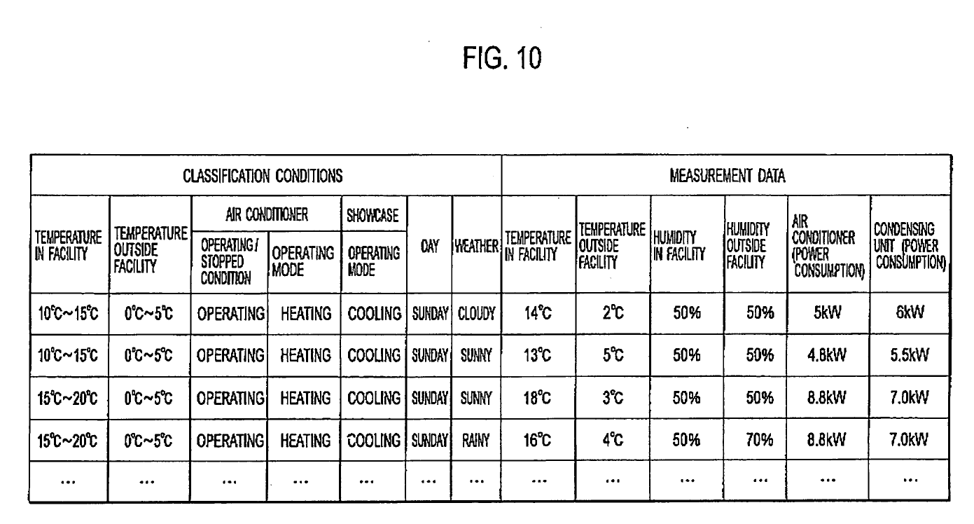

FIG. 10 is a table showing an example of a table according to an example of the present invention. As shown in FIG. 10, the modeling device 100 stores a table containing the measurement data classified for each classification condition, in correspondence with the classification conditions. Incidentally, in FIG. 10, the range of temperatures in the facility, the range of temperatures outside the facility, the operating/stopped condition (of the air conditioner), the operating mode (of the air conditioner) and the operating mode (of the showcase) are shown as an example of the classification conditions. Also, the temperature and humidity in the facility, the temperature and humidity outside the facility, and the power consumption of each equipments are shown as an example of the measurement data. Incidentally, the information in the table shown in FIG. 9 is used to generate the table shown in FIG. 10.

### (Example of Parameter Identification)

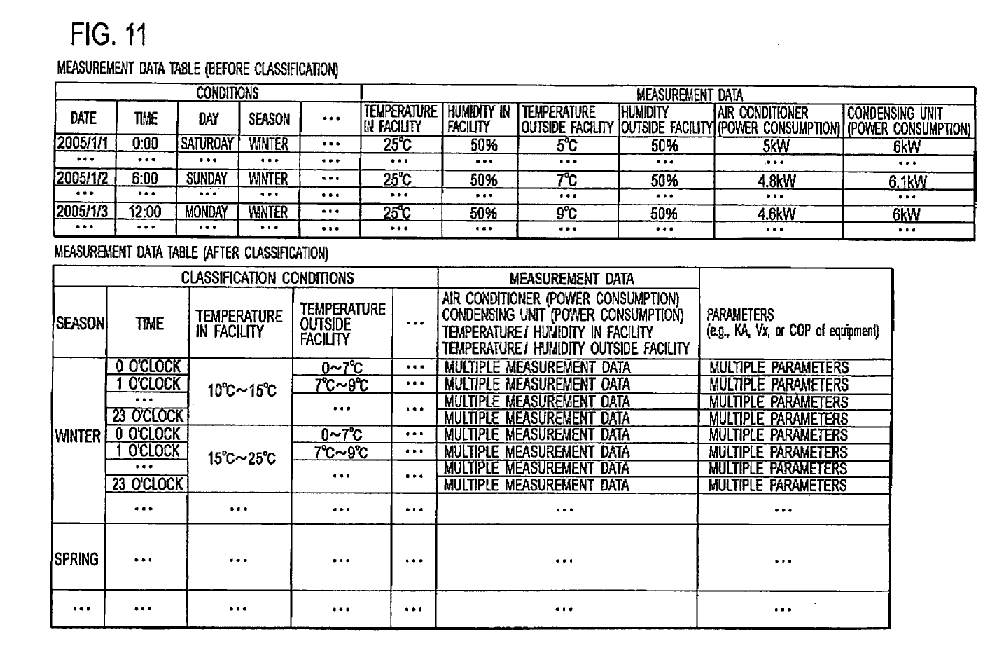

FIG. 11 is a table for explaining a parameter identification method according to an example of the present invention. As shown in FIG. 11, the modeling device 100 stores the table (that is, the measurement data table (before the classification)) containing the conditions for which the measurement data is acquired, in correspondence with the measurement data. Incidentally, in FIG. 11, the date, the time, the day and the season are shown as an example of the conditions for which the measurement data is acquired; however, it is to be understood that the conditions are not so limited. In other words, it is a matter of course that the measurement data table (before the classification) may contain the operation condition of each equipments provided in the facility 10, the weather information, or the like, in correspondence with the measurement data.

As shown in FIG. 11, the modeling device 100 stores the table (that is, the measurement data table (after the classification)) containing the classification conditions in correspondence with the measurement data classified for each classification condition. Incidentally, in FIG. 11, the season, the time, the temperature in the facility, and the temperature outside the facility are shown as an example of the classification conditions; however, it is to be understood that the classification conditions are not so limited. In other words, it is a matter of course that the measurement data table (after the classification) may contain the classification conditions appropriately selected according to the type of the facility 10 or the like, in correspondence with the measurement data.

Also, as shown in FIG. 11, the measurement data table (after the classification) contains the classification conditions in correspondence with the parameters. Incidentally, the parameters include, for example, the coefficient of heat transfer (KA), the coefficient of ventilation (Vx), and the COP of each equipments. Also, the parameters are identified based on the measurement data classified for each classification condition.

### (Concept of Method for Selecting Classification Conditions)

Description will be given below with regard to the concept of the method for selecting classification conditions, taking an example where the facility 10 is the convenience store and an example where the facility 10 is the supermarket.

### (Convenience Store)

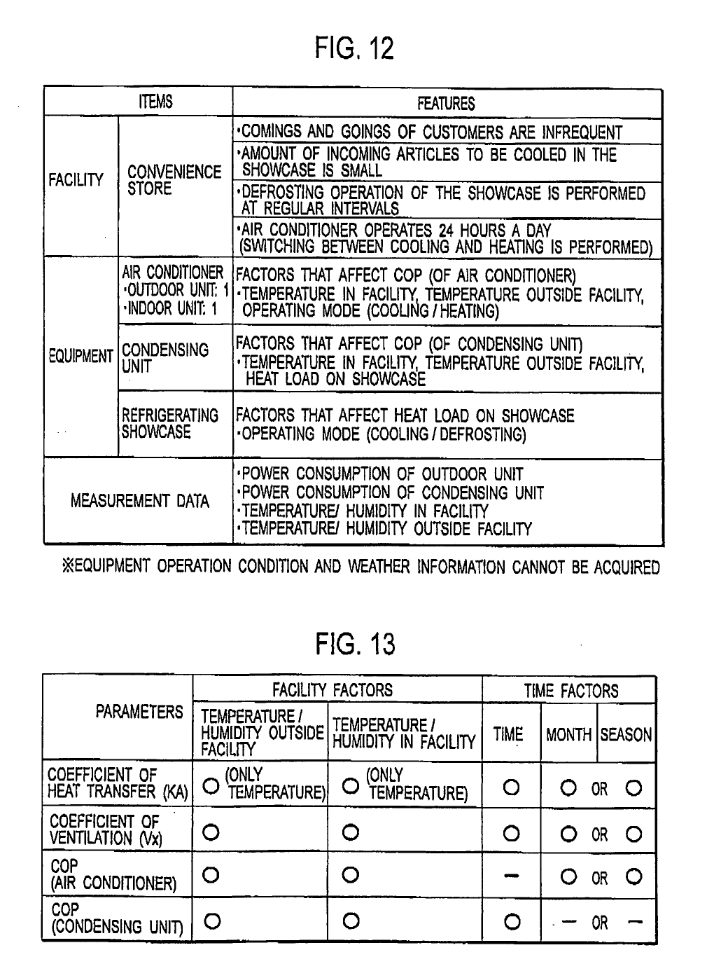

Description will be given below, taking as an example the convenience store having features shown in FIG. 12. FIG. 12 is a table for explaining the features of the convenience store according to an example of the present invention. Specifically, as shown in FIG. 12, the convenience store is characterized in that the comings and goings of customers are relatively infrequent, the amount of incoming articles is small, the showcase has a defrosting operation mode, and the store is open 24 hours a day. Also, in FIG. 12, there is shown an example where the operation condition of equipment provided in the convenience store or weather information cannot be acquired.

Here, the classification conditions for the convenience store are selected based on the features of the convenience store.

For example, as for a heat balance model simplified for the convenience store, as shown in FIG. 13, the temperature and humidity outside the facility, the temperature and humidity in the facility, the time, the month, the season and the like are selected as the classification conditions. FIG. 13 is a table for explaining the classification conditions for the convenience store according to an example of the present invention.

Specifically, as for the COP (of the air conditioner), the air conditioner operates 24 hours a day, and the comings and goings of customers are infrequent, and thus, the time is not selected as the classification condition without problems. On the other hand, it is preferable that the month or the season be selected as the classification condition, because the COP (of the air conditioner) is affected by the temperature outside the facility or the like. Also, it is preferable that the month or the season having correlation to the operation mode of the air conditioner be selected as the classification condition, because the operation condition (or the operation mode) of the six conditioner cannot be acquired.

As for the COP (of the condensing unit), the COP (of the condensing unit) is not affected by the month or the season, and thus, the month or the season is not selected as the classification condition without problems; however, the COP (of the condensing unit) is affected by the entry of articles or the like, and thus, it is preferable that the time be selected as the classification condition. Also, it is preferable that the time having correlation to the operation mode of the showcase be selected as the classification condition, because the operation condition (or the operation mode) of the showcase cannot be acquired.

As for the coefficient of heat transfer (KA), the coefficient of heat transfer (KA) is affected by the temperature in the facility or the temperature outside the facility, and thus, it is preferable that the temperature in the facility or the temperature outside the facility be selected as the classification condition. Preferably, the time, the month or the season having correlation to temperature distribution or radiation heat is selected as the classification condition, taking into account the influence of the temperature distribution or sunlight radiation heat in parts of the facility.

As for the coefficient of ventilation (Vx), the coefficient of ventilation (Vx) is affected by the temperature and humidity in the facility or the temperature and humidity outside the facility, and thus, it is preferable that the temperature and humidity in the facility or the temperature and humidity outside the facility be selected as the classification condition. Preferably, the time, the month or the season is selected as the classification condition, taking into account the influence of the temperature and humidity outside the facility.

### (Supermarket)

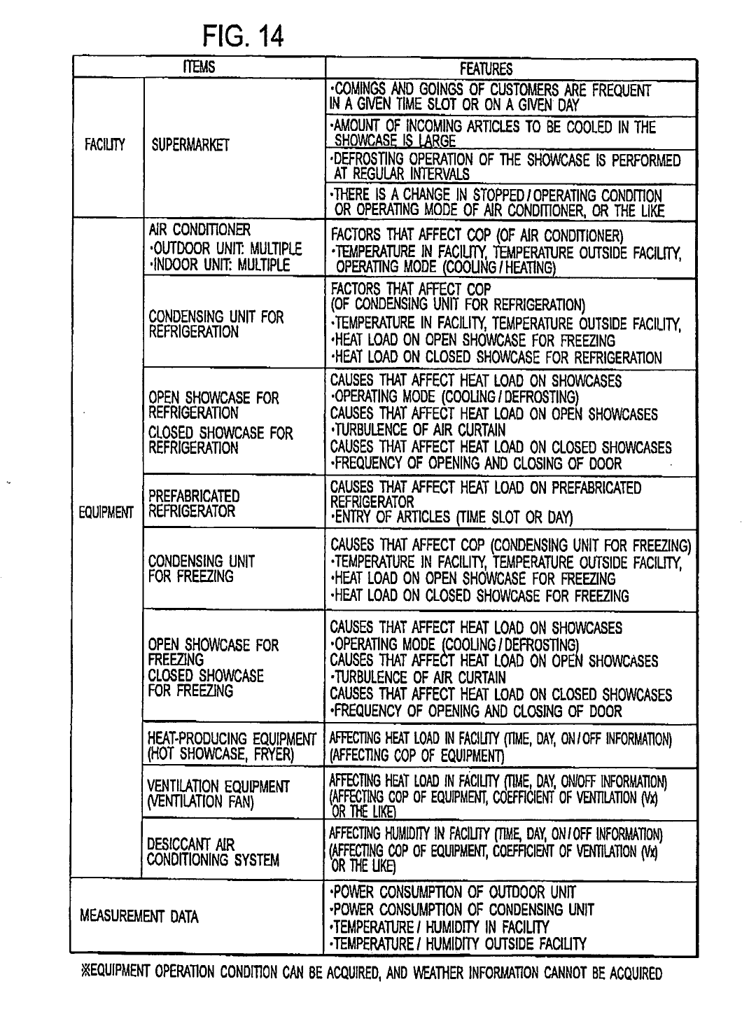

Description will be given below, taking as an example the supermarket having features shown in FIG. 14. FIG. 14 is a table for explaining the features of the supermarket according to an example of the present invention. Specifically, as shown in FIG. 14, the supermarket is characterized in that the comings and goings of customers are frequent in a given time slot or on a given day, the amount of incoming articles is large, the air conditioner is in varying operation conditions, and the number of separate equipments provided in the facility is large, as compared to the convenience store. Also, in FIG. 14, there is shown an example where the operation condition of equipment provided in the supermarket can be acquired, but weather information cannot be acquired.

Here, the classification conditions for the supermarket are selected based on the features of the supermarket.

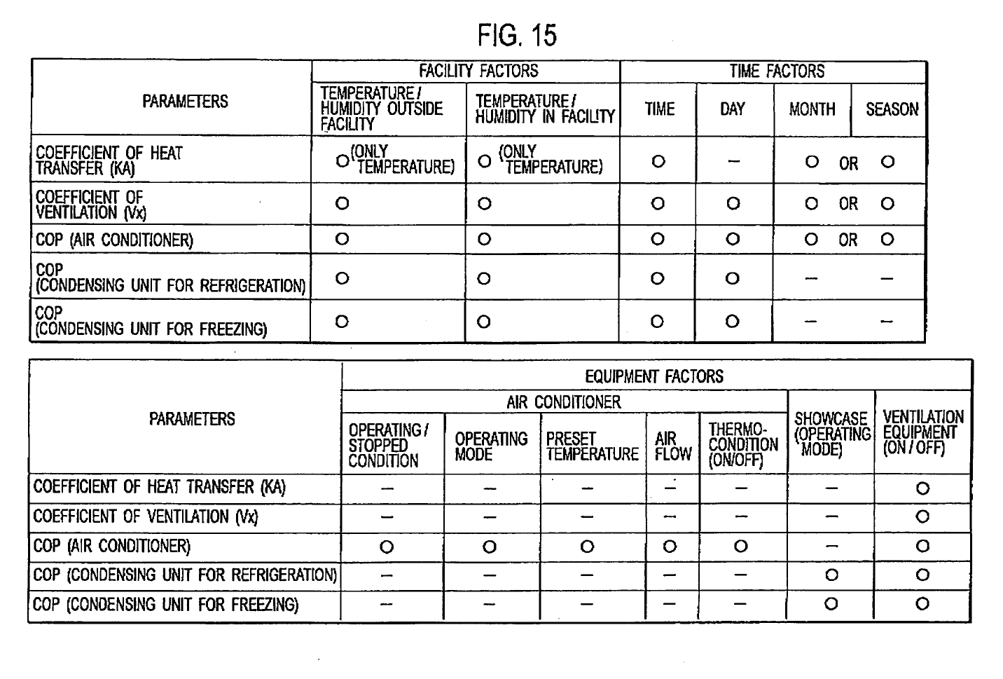

For example, for a heat balance model simplified for the supermarket, as shown in FIG. 15, a larger number of conditions than those for the convenience store are selected as the classification conditions. FIG. 15 is a table for explaining the classification conditions for the supermarket according to an example of the present invention.

Specifically, in the supermarket, as for the COP (of the air conditioner), the comings and goings of customers are frequent on the given day, and thus, it is preferable that the day be selected as the classification condition. Also, the comings and goings of customers are frequent in the given time slot, and the COP is affected by customers' heat, and thus, it is preferable that the time be selected as the classification condition.

Also, as for the COP (of the air conditioner), the COP (of the air conditioner) is affected by the operation condition of the air conditioner (e.g., the operating/stopped condition, the operating mode, the preset temperature, the air flow, or the on/off thermo-control), and thus, it is preferable that the operation condition of the air conditioner be selected as the classification condition.

Further, as for the COP (of the air conditioner), it is preferable that the time, the month or the season having correlation to an “on” period of heat-producing equipment be selected as the classification condition, taking into account the influence of heat produced by the heat-producing equipment upon the heat load on the air conditioner. For example, if the heat-producing equipment is oden equipment used in winter only, the month or the season is selected as the classification condition. If the heat-producing equipment is a fryer (or cookware), the time or the day having correlation to the schedule of use of the fryer (or cookware) is selected as the classification condition.

As for the COP (of the condensing unit), the COP (of the condensing unit) is affected by the operation condition of the showcase (e.g., the operating mode), and thus, it is preferable that the operating mode (cooling/defrosting) be selected as the classification condition. Also, as for the COP (of the condensing unit), it is preferable that the time having correlation to the entry of articles be selected as the classification condition, allowing for a temporary increase in heat load at the time of entry of articles into a prefabricated refrigerator or the like. Further, as for the COP (of the condensing unit), it is preferable that the time or the day having correlation to the comings and goings of customers be selected as the classification condition, because the comings and goings of customers are affected by the turbulence of the air curtain of the open showcase, the opening and closing of the door of the closed showcase, or the like.

As for the coefficient of heat transfer (KA), the coefficient of heat transfer (KA) is affected by the temperature in the facility or the temperature outside the facility; and thus, it is preferable that the temperature in the facility or the temperature outside the facility be selected as the classification condition. Preferably, the time, the month or the season having correlation to temperature distribution or radiation heat is selected as the classification condition, taking into account the influence of the temperature distribution or sunlight radiation heat in the parts of the facility.

As for the coefficient of ventilation (Vx), the coefficient of ventilation (Vx) is affected by the temperature and humidity in the facility or the temperature and humidity outside the facility; and thus, it is preferable that the temperature and humidity in the facility or the temperature and humidity outside the facility be selected as the classification condition. Preferably, the time, the month or the season having correlation to the temperature and humidity outside the facility is selected as the classification condition, taking into account the influence of the temperature and humidity outside the facility. Also, as for the coefficient of ventilation (Vx), it is preferable that the time or the day having correlation to the comings and goings of customers be selected as the classification condition, taking into account the comings and goings of customers.

Further, the temperature and humidity in the facility is affected by whether or not the ventilation equipment (e.g., the ventilation fan or the desiccant air conditioning system) is in operating condition (that is, whether the ventilation equipment is on or off), and thus, as for all parameters, it is preferable that the operation condition of the ventilation equipment (ON/OFF) be selected as the classification condition.

Incidentally, if information on whether the ventilation equipment is on or off cannot be acquired, the operation records of the ventilation equipment may be referred to so that the operating time of ventilation equipment or the like is acquired and selected as the classification condition.

### Second Embodiment

Description will be given below with reference to the drawing, with regard to a second embodiment of the present invention. Description will be given below mainly with regard to the points of difference between the above-mentioned first embodiment and the second embodiment.

Specifically, in the above-mentioned first embodiment, the facility 10 is provided with the air conditioners, the condensing units and the showcases. On the other hand, in the second embodiment, the facility 10 is provided with the air conditioners alone and is not provided with the condensing units and the showcases.

### (Outline of Heat Balance Model)

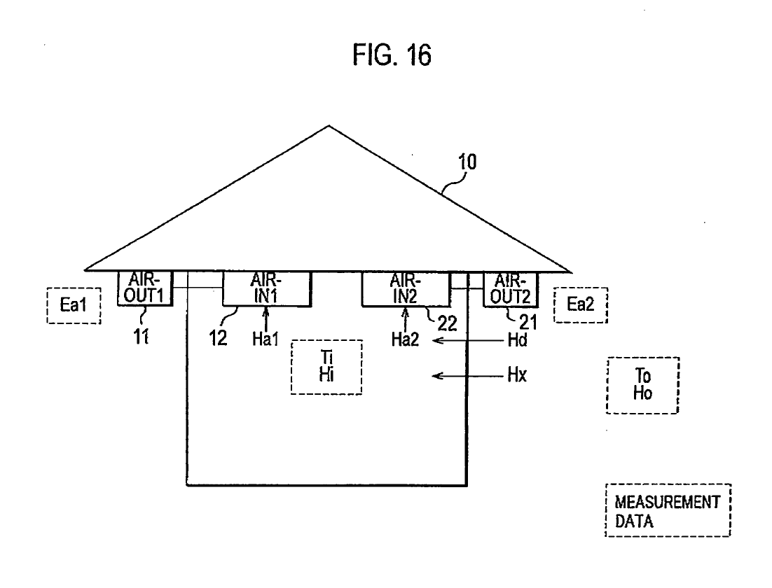

Description will be given below with reference to the drawing, with regard to an outline of a heat balance model according to the second embodiment of the present invention. FIG. 16 is a diagram showing the outline of the heat balance model according to the second embodiment of the present invention.

As shown in FIG. 16, the facility 10 contains a plurality of equipments (e.g., the outdoor unit 11, the indoor unit 12, the outdoor unit 21, and the indoor unit 22). Incidentally, the facility 10 is the facility provided with the air conditioners alone, and is, for example, an office or the like.

Here, the conductive heat load (Hd [kJ/s]) applied to the facility 10 is found by the following Equation (1), as in the case of the first embodiment.

Hd=KA(To−Ti) (1)

The ventilation heat load (Hx [kJ/s]) on the facility 10 is found by the following Equation (2), as in the case of the first embodiment.

Hx=Vx{H(To,Ho)−H(Ti,Hi)} (2)

The heat load applied to the air conditioners (or the indoor units 12 and 22) is found by the following Equation (10a).

Ha1+Ha2=Hd+Hx (10a)

The power consumption [kW] of the outdoor unit 11 is found by the following Equation (11), as in the case of the first embodiment.

Ea1=Ha1/COPa1 (11)

The power consumption [kW] of the outdoor unit 21 is found by the following Equation (12), as in the case of the first embodiment.

Ea2=Ha2/COPa2 (12)

Here, combining Equations (10a) to (12) into an equation not using the heat load (Ha1 and Ha2) leads to the following Equation (13a).

Ea1*COPa1+Ea2*COPa2=Nd+Hx (13a)

Here, Equation (13a) contains four parameters, namely, COPa1, COPa2, KA and Vx, and thus, at least four sets of measurement data can be prepared to identify the parameters.

### Third Embodiment

Description will be given below with reference to the drawing, with regard to a third embodiment of the present invention. Description will be given below mainly with regard to the points of difference between the above-mentioned first embodiment and the third embodiment.

Specifically, in the above-mentioned first embodiment, the facility 10 is provided with the air conditioners, the condensing units and the showcases. On the other hand, in the third embodiment, the facility 10 is provided with the condensing units and the showcases alone and is not provided with the air conditioners.

### (Outline of Heat Balance Model)

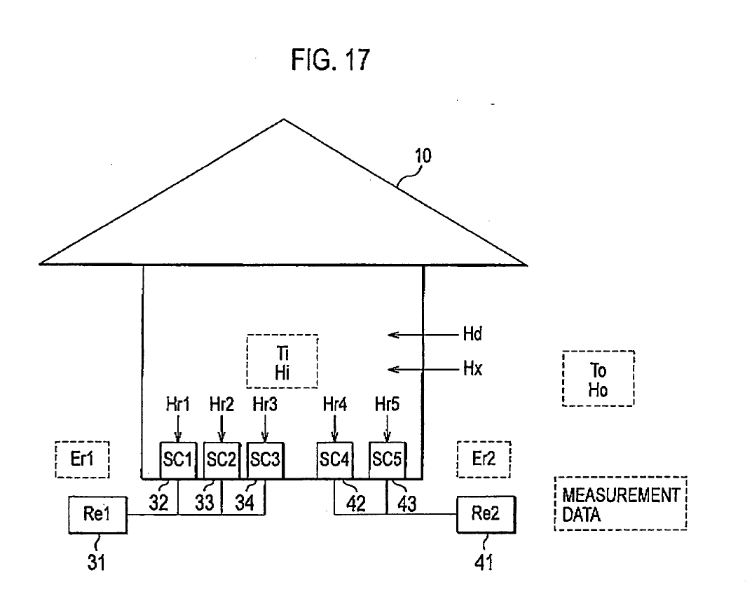

Description will be given below with reference to the drawing, with regard to an outline of a heat balance model according to the third embodiment of the present invention. FIG. 17 is a diagram showing the outline of the heat balance model according to the third embodiment of the present invention.

As shown in FIG. 17, the facility 10 contains a plurality of equipments (e.g., the condensing unit 31, the showcases 32 to 34, the condensing unit 41, and the showcases 42 and 43). Incidentally, the facility 10 is the facility provided with the condensing units and equipment (e.g., the showcases, a prefabricated refrigerator or a prefabricated freezer) connected to the condensing units, and is, for example, a refrigerated warehouse or the like.

Here, the conductive heat load (Hd [kJ/s]) applied to the facility 10 is found by the following Equation (1), as in the case of the first embodiment.

Hd=KA(To−Ti) (1)

The ventilation heat load (Hx [kJ/s]) on the facility 10 is found by the following Equation (2), as in the case of the first embodiment.

Hx=Vx{H(To,Ho)−H(Ti,Hi)} (2)

Then, the sum of heat loads applied to the showcases 32 to 84 and the showcases 42 and 43 allowing for the conductive heat load (Hd [kJ/s]) and the ventilation heat load (Hx [kJ/s]) is found by the following Equation (14).

(Hr1+Hr2+Hr3+Hr4+Hr5)=Hd+Hx (14)

It should be here noted that Hr1 to Hr5 represent the heat loads applied to the showcases 32 to 34 and the showcases 42 and 43 allowing for the conductive heat load (Hd [kJ/s]) and the ventilation heat load (Hx [kJ/s]).

The power consumption [kW] of the condensing unit 31 is found by the following Equation (8b).

Er1=(Hr1+Hr2+Hr3)/COPr1 (8b)

The power consumption [kW] of the condensing unit 41 is found by the following Equation (9b).

Er2=(Hr4+Hr5)/COPr2 (9b)

Here, combining Equations (3b) to (9b) and Equation (14) into an equation not using the heat loads (Hr1 to Hr5) leads to the following Equation (15).

Er1*COPr1+Er2*COPr2=Hd+Hx (15)

Here, Equation (15) contains four parameters, namely, COPr1, COPr2, KA and Vx, and thus, at least four sets of measurement data can be prepared to identify the parameters.

### Fourth Embodiment

Description will be given below with reference to the drawing, with regard to a fourth embodiment of the present invention. Description will be given below mainly with regard to the points of difference between the above-mentioned first embodiment and the fourth embodiment.

Specifically, in the above-mentioned first embodiment, the parameters are COPa1, COPa2, COPr1, COPr2, KA and Vx. On the other hand, in the fourth embodiment, the parameters are COPa1, COPa2, COPr1, COPr2, and KA. Thus, the identification of the parameters does not allow for the ventilation heat load (Hx [kJ/s]) on the facility 10.

### (Outline of Heat Balance Model)

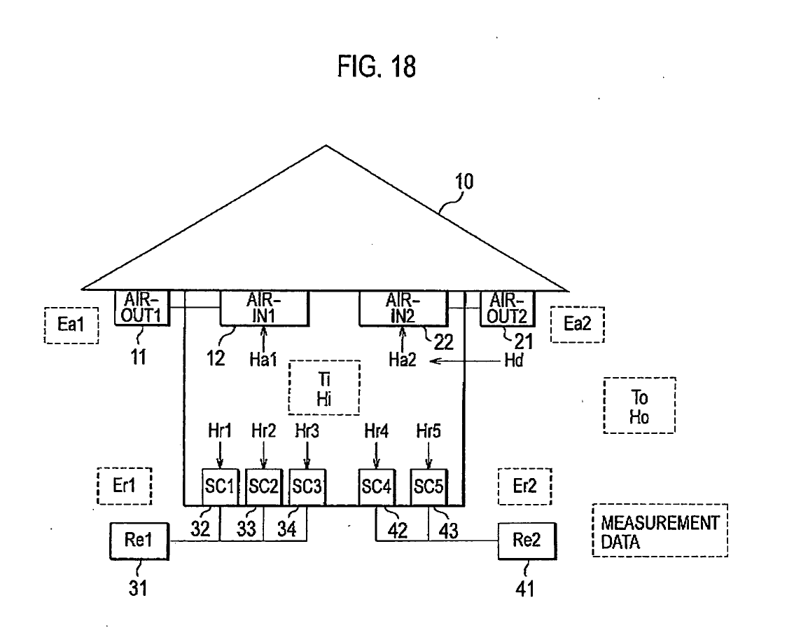

Description will be given below with reference to the drawing, with regard to an outline of a heat balance model according to the fourth embodiment of the present invention. FIG. 18 is a diagram showing the outline of the heat balance model according to the fourth embodiment of the present invention. As shown in FIG. 18, the facility 10 has the same configuration as shown in FIG. 1. Incidentally, the configuration shown in FIG. 18 is different from that shown in FIG. 1 in that no consideration is given to the ventilation heat load (Hx [kJ/s]) on the facility 10, as mentioned above.

Here, the conductive heat load aid [kJ/s]) applied to the facility 10 is found by the following Equation (1), as in the case of the first embodiment.

Hd=KA(To−Ti) (1)

The heat loads (Hr [kJ/s]) applied to the showcases are found by the following Equations (3) to (7), as in the case of the first embodiment.

Hr1=Vr1{H(Ti,Hi)−H(Tt,Ht)} (3)

Hr2=Vr2{H(Ti,Hi)−H(Tt,Ht)} (4)

Hr3=Vr3{H(Ti,Hi)−H(Tt,Ht)} (5)

Hr4=Vr4{H(Ti,Hi)−H(Tt,Ht)} (6)

Hr5=Vr5{H(Ti,Hi)−H(Tt,Ht)} (7)

The power consumption [kW] of the condensing unit 31 is found by the following Equation (8), as in the case of the first embodiment.

Er1=(Hr1+Hr2+Hr3)/COPr1 (8)

The power consumption [kW] of the condensing unit 41 is found by the following Equation (9), as in the case of the first embodiment.

Er2=(Hr4+Hr5)/COPr2 (9)

The heat load applied to the air conditioners (or the indoor units 12 and 22) is found by the following Equation (10c).

Ha1+Ha2=Hd−(Hr1+Hr2+Hr3+Hr4+Hr5) (10c)

The power consumption [kW] of the outdoor unit 11 is found by the following Equation (11), as in the case of the first embodiment.

Ea1=Ha1/COPa1 (11)

The power consumption [kW] of the outdoor unit 21 is found by the following Equation (12), as in the case of the first embodiment.

Ea1=Ha2/COPa2 (12)

Here, combining Equations (10c) to (12) into an equation not using the heat load (Ha1 and Ha2) leads to the following Equation (13c).

Ea1*COPa1+Ea2*COPa2=Hd−(Hr1+Hr2+Hr3+Hr4+Hr5) (13c)

Here, Equation (13c) contains three parameters, namely, COPa1, COPa2 and KA, and thus, at least three sets of measurement data can be prepared to identify the parameters.

### Fifth Embodiment

Description will be given below with reference to the drawing, with regard to a fifth embodiment of the present invention. Description will be given below mainly with regard to the points of difference between the above-mentioned second embodiment and the fifth embodiment.

Specifically, in the above-mentioned second embodiment, the parameters are COPa1, COPa2, KA and Vx. On the other hand, in the fifth embodiment, the parameters are COPa1, COPa2 and KA. Thus, the identification of the parameters does not allow for the ventilation heat load (fix [kJ/s]) on the facility 10.

### (Outline of Heat Balance Model)

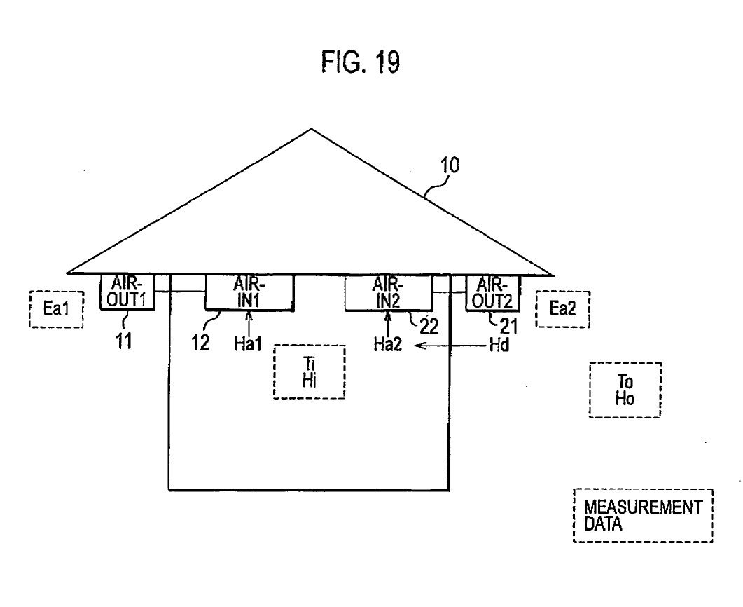

Description will be given below with reference to the drawing, with regard to an outline of a heat balance model according to the fifth embodiment of the present invention. FIG. 19 is a diagram showing the outline of the heat balance model according to the fifth embodiment of the present invention. As shown in FIG. 19, the facility 10 has the same configuration as shown in FIG. 16. Incidentally, the configuration shown in FIG. 19 is different from that shown in FIG. 16 in that no consideration is given to the ventilation heat load (Hx [kJ/s]) on the facility 10, as mentioned above.

Here, the conductive heat load (Hd [kJ/s]) applied to the facility 10 is found by the following Equation (1), as in the case of the second embodiment.

Hd=KA(To−Ti) (1)

The heat load applied to the air conditioners (or the indoor units 12 and 22) is found by the following Equation (104.

Ha1+Ha2=Hd (10d)

The power consumption [kW] of the outdoor unit 11 is found by the following Equation (11), as in the case of the second embodiment.

Ea1=Ha1/COPa1 (11)

The power consumption [kW] of the outdoor unit 21 is found by the following Equation (12), as in the case of the second embodiment.

Ea1=Ha2/COPa2 (12)

Here, combining Equations (10d) to (12) into an equation not using the heat load (Ha1 and Ha2) leads to Equation (13d).

Ea1*COPa1+Ea2*COPa2=Hd (13d)

Here, Equation (13d) contains three parameters, namely, COPa1, COPa2 and KA, and thus, at least three sets of measurement data can be prepared to identify the parameters.

### Sixth Embodiment

Description will be given below with reference to the drawing, with regard to a sixth embodiment of the present invention. Description will be given below mainly with regard to the points of difference between the above-mentioned third embodiment and the sixth embodiment.

Specifically, in the above-mentioned third embodiment, the parameters are COPr1, COPr2, KA and Vx. On the other hand, in the sixth embodiment, the parameters are COPr1, COPr2 and KA. Thus, the identification of the parameters does not allow for the ventilation heat load (Hx [kJ/s]) on the facility 10.

### (Outline of Heat Balance Model)

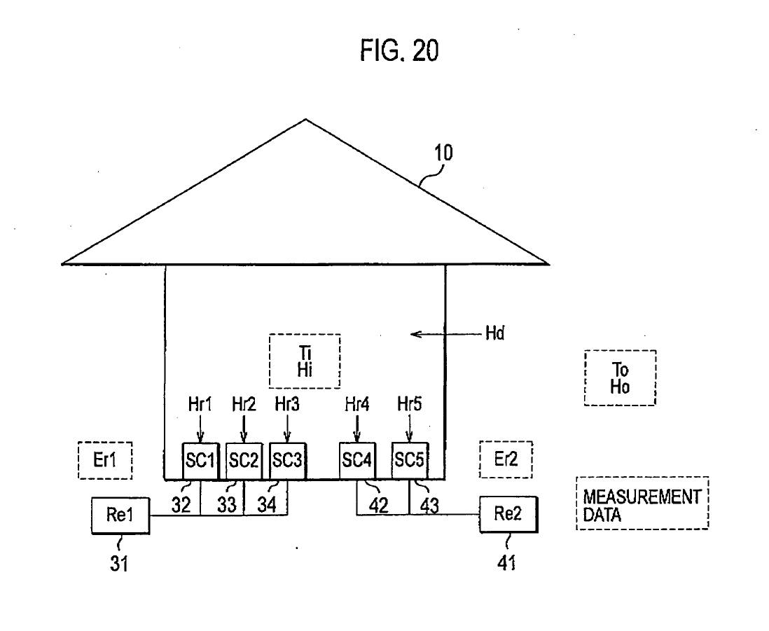

Description will be given below with reference to the drawing, with regard to an outline of a heat balance model according to the sixth embodiment of the present invention. FIG. 20 is a diagram showing the outline of the heat balance model according to the sixth embodiment of the present invention. As shown in FIG. 20, the facility 10 has the same configuration as shown in FIG. 17. Incidentally, the configuration shown in FIG. 20 is different from that shown in FIG. 17 in that no consideration is given to the ventilation heat load (Hx [kJ/s]) on the facility 10, as mentioned above.

Here, the conductive heat load (Hd [kJ/s]) applied to the facility 10 is found by the following Equation (1), as in the case of the third embodiment.

Hd=KA(To−Ti) (1)

The sum of heat loads applied to the showcases 32 to 34 and the showcases 42 and 43 allowing for the conductive heat load (Hd [kJ/s]) is found by the following Equation (14e).

(Hr1+Hr2+Hr3+Hr4+Hr5)=Hd (14e)

It should be here noted that Hr1 to Hr5 represent the heat loads applied to the showcases 32 to 34 and the showcases 42 and 43 allowing for the conductive heat load (Hd [kJ/s]).

The power consumption [kW] of the condensing unit 31 is found by the following Equation (8b).

Er1=(Hr1+Hr2+Hr3)/COPr1 (8b)

The power consumption [kW] of the condensing unit 41 is found by the following Equation (9b).

Er2=(Hr4+Hr5)/COPr2 (9b)

Here, combining Equations (3b) to (9b) and Equation (14e) into an equation not using the heat loads (Hr1 to Hr5) leads to the following Equation (15e).

Er1*COPr1+Er2*COPr2=Hd (15e)

Here, Equation (15e) contains three parameters, namely, COPr1, COPr2, and KA, and thus, at least three sets of measurement data can be prepared to identify the parameters.

### Seventh Embodiment

Description will be given below with reference to the drawing, with regard to a seventh embodiment of the present invention. Description will be given below mainly with regard to the points of difference between the above-mentioned second embodiment and the seventh embodiment.

Specifically, in the above-mentioned second embodiment, a single floor is provided. On the other hand, in the seventh embodiment, multiple floors are provided.

### (Outline of Heat Balance Model)

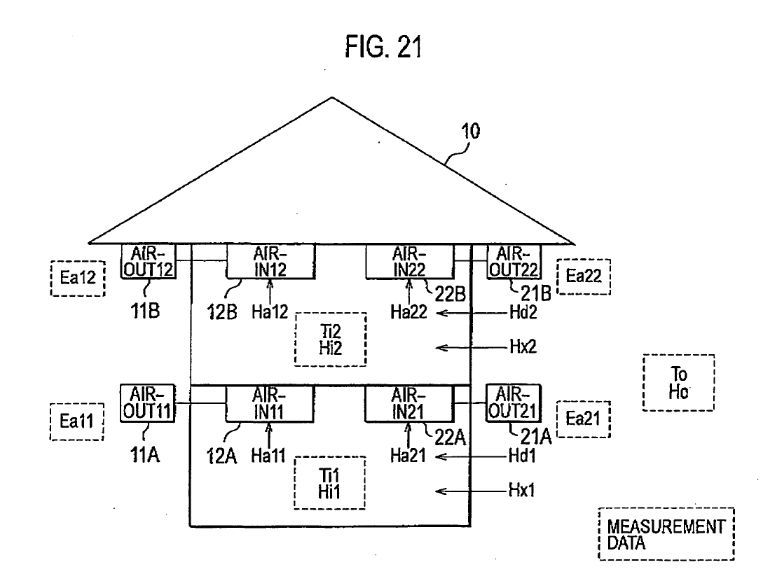

Description will be given below with reference to the drawing, with regard to an outline of a heat balance model according to the seventh embodiment of the present invention. FIG. 21 is a diagram showing the outline of the heat balance model according to the seventh embodiment of the present invention.

As shown in FIG. 21, the facility 10 contains a plurality of equipments (e.g., an outdoor unit 11A, an indoor unit 12A, an outdoor unit 21A, an indoor unit 22A, an outdoor unit UB, an indoor unit 12B, an outdoor unit 21B, and an indoor unit 22B). Incidentally, the facility 10 is the facility provided with the air conditioners alone, and is, for example, an office or the like.

Incidentally, the outdoor unit 11A, the indoor unit 12A, the outdoor unit 21A and the indoor unit 22A are provided on the lower floor, and the outdoor unit 11B, the indoor unit 12B, the outdoor unit 21B and the indoor unit 22B are provided on the upper floor.

If the facility 10 is formed of the multiple floors as mentioned above, the parameters are identified for each of the floors. Identification of the parameters is the same as the above-mentioned second embodiment.

Specifically, the parameters for the lower floor are COPa11, COPa21, KA1 and Vx1, and the parameters for the upper floor are COPa12, COPa22, KA2 and Vx2.

Incidentally, COPa11 and COPa21 are the coefficients of performance of the outdoor units 11A and 21A provided on the lower floor, and COPa12 and COPa22 are the coefficients of performance of the outdoor units 11B and 21B provided on the upper floor.

### Eighth Embodiment

Description will be given below with reference to the drawing, with regard to an eighth embodiment of the present invention. Description will be given below mainly with regard to the points of difference between the above-mentioned first embodiment and the eighth embodiment.

Specifically, in the above-mentioned first embodiment, the equipment connected to the condensing unit is the showcase. On the other hand, in the eighth embodiment, a prefabricated refrigerator is connected to the condensing unit.

### (Outline of Heat Balance Model)

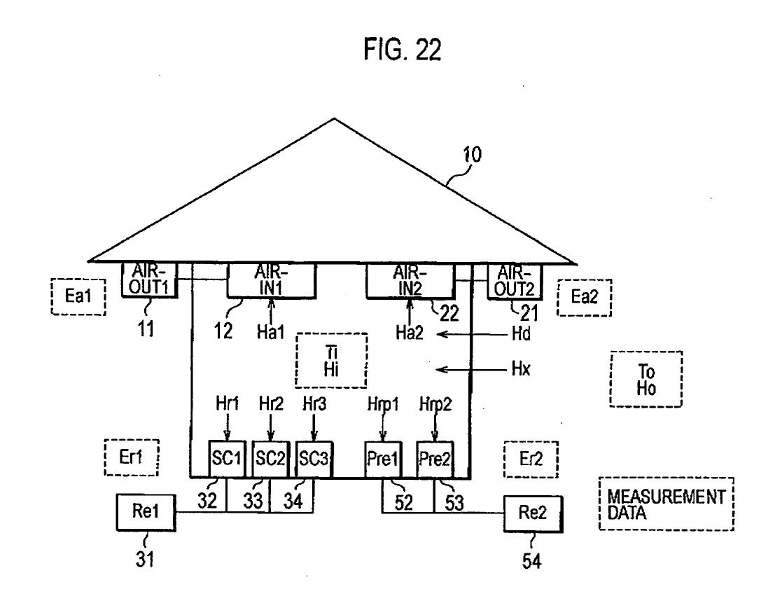

Description will be given below with reference to the drawing, with regard to an outline of a heat balance model according to the eighth embodiment of the present invention. FIG. 22 is a diagram showing the outline of the heat balance model according to the eighth embodiment of the present invention.

As shown in FIG. 22, the facility 10 contains similar equipment to the equipment shown in FIG. 1, and includes prefabricated storages 62 and 58 rather than the showcases 42 and 43.

The prefabricated storages 52 and 53 include a prefabricated refrigerator in which articles are refrigerated, and a prefabricated freezer in which articles are frozen. The prefabricated refrigerator or the prefabricated freezer is provided with a door through which a person enters the warehouse, a door through which articles are taken out of the warehouse, and the like, which are separate from each other.

Here, the conductive heat load (Hd [kJ/s]) applied to the facility 10 is found by the following Equation (1), as in the case of the first embodiment.

Hd=KA(To−Ti) (1)

The ventilation heat load (Hx [kJ/s]) on the facility 10 is found by the following Equation (2), as in the case of the first embodiment.

Hx=Vx{H(To,Ho)−H(Ti,Hi)} (2)

The heat loads (Hr [kJ/s]) applied to the showcases 32 to 34 are found by the following Equations (3) to (5), as in the case of the first embodiment.

Hr1=Vr1{H(Ti,Hi)−H(Tt,Ht)} (3)

Hr2=Vr2{H(Ti,Hi)−H(Tt,Ht)} (4)

Hr3=Vr3{H(Ti,Hi)−H(Tt,Ht)} (5)

Heat load (Hr [kJ/s]) applied to the prefabricated storage 52 is found by the following Equation (6h).

Hrp1=Vrp1{H(Ti,Hi)−H(Tt,Ht)} (6h)

Heat load applied to the prefabricated storage 53 is found by the following Equation (7h).

Hrp2=Vrp2{H(Ti,Hi)−H(Tt,Ht)} (7h)

Here, H(Tt,Ht) represents enthalpy of cooling air ejected by the prefabricated refrigerators, and, for example, H(0° C., 100%) is set if the prefabricated storage is the prefabricated refrigerator, or H(−20° C., 100%) is sot if the prefabricated storage is the prefabricated freezer. Also, Vrp1 and Vrp2 represent the amounts of substitution air [kg/s] in the prefabricated storages, respectively, and are known values.

The power consumption [kW] of the condensing unit 31 is found by the following Equation (8), as in the case of the first embodiment.

Er1=(Hr1+Hr2+Hr3)/COPr1 (8)

The power consumption [kW] of the condensing unit 41 is found by the following Equation (9h).

Er2=(Hrp1+Hrp2)/COPr2 (9h)

The heat load applied to the air conditioners (or the indoor units 12 and 22) is found by the following Equation (10h).

Ha1+Ha2=Hd+Hx−(Hr1+Hr2+Hr3+Hrp1+Hrp2) (10h)

The power consumption [kW] of the outdoor unit 11 is found by the following Equation (11), as in the case of the first embodiment.

Ea1=Ha1/COPa1 (11)

The power consumption [kW] of the outdoor unit 21 is found by the following Equation (12), as in the case of the first embodiment.

Ea2=Ha2/COPa2 (12)

Here, combining Equations (10h) to (12) into an equation not using the heat load (Ha1 and Ha2) leads to the following Equation (13h).

Ea1*COPa1+Ea2*COPa2=Hd+Hx−(Hr1+Hr2+Hr3+Hrp1+Hrp2) (13h)

Here, Equation (13h) contains four parameters, namely, COPa1, COPa2, KA and Vx, and thus, at least four sets of measurement data can be prepared to identify the parameters.

### (Concept of Method for Selecting Classification Conditions)

Description will be given below with regard to the concept of the method for selecting classification conditions, taking an example where the facility 10 is the office and an example where the facility 10 is the refrigerated warehouse.

### (Office)

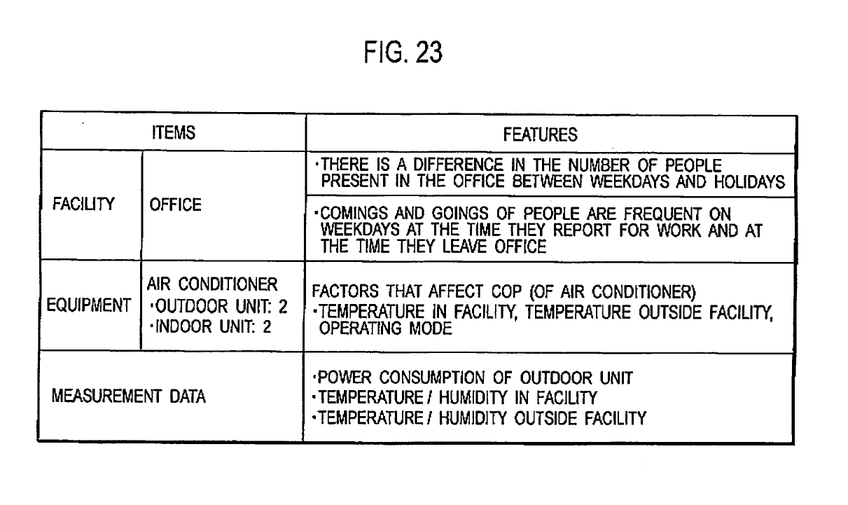

Description will be given below, taking as an example the office having features shown in FIG. 23. The office is an example of the facility 10 provided with the air conditioners alone and not provided with the condensing units. FIG. 23 is a table for explaining the features of the office according to an example of the present invention.

Specifically, as shown in FIG. 23, the office is characterized in that there is a difference in the number of people present in the office between weekdays and holidays, and the comings and goings of people are frequent on weekdays at the time they report for work and at the time they leave the office. Also, in FIG. 23, there is shown an example where the operation condition of the equipment provided in the office or weather information can be acquired.

Here, the classification conditions for the office are selected based on the features of the office.

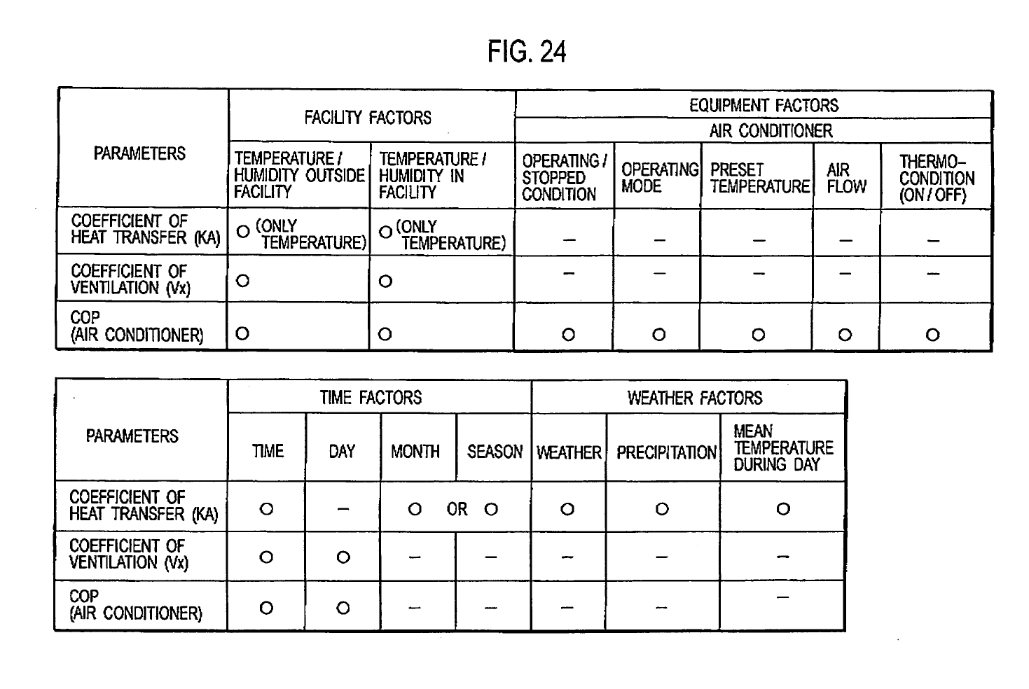

For example, as for a heat balance model simplified for the office, as shown in FIG. 24, the facility factors, the equipment factors, the time factors and the weather factors are selected as the classification conditions. FIG. 24 is a table for explaining the classification conditions for the office according to an example of the present invention.

Specifically, as for the COP (of the air conditioner), the COP is affected by the influence of the temperature and humidity in the facility or the temperature and humidity outside the facility or the like. Thus, it is preferable that the temperature and humidity in the facility or the temperature and humidity outside the facility be selected as the classification condition. The COP (of the air conditioner) is affected by the operation mode of the air conditioner, and thus, it is preferable that the operating/stopped condition, the operating mode, the preset temperature, the air flow, or the on/off thermo-control be selected as the classification condition.

Preferably, the day is selected as the classification condition, because the difference in the number of people present lies between weekdays and holidays and affects the heat load applied to the air conditioner. Preferably, the time and the day having correlation to the comings and goings of people are selected as the classification conditions, because the comings and goings of people are frequent on weekdays at the time they report for work and at the time they leave the office.

As for the coefficient of heat transfer (KA), the coefficient of heat transfer (KA) is affected by the temperature in the facility or the temperature outside the facility. Thus, it is preferable that the temperature in the facility or the temperature outside the facility be selected as the classification condition. Preferably, the time, the month or the season having correlation to the temperature distribution or the radiation heat is selected as the classification condition, taking into account the influence of the temperature distribution or the sunlight radiation heat in the parts of the facility. Preferably, the weather, the precipitation, or the mean temperature during a day having correlation to the radiation heat is selected as the classification condition, taking into account the influence of the sunlight radiation heat.

As for the coefficient of ventilation (Vx), the coefficient of ventilation (Vx) is affected by the temperature and humidity in the facility or the temperature and humidity outside the facility. Thus, it is preferable that the temperature and humidity in the facility or the temperature and humidity outside the facility be selected as the classification condition. Preferably, the time and the day having correlation to the comings and goings of people are selected as the classification conditions, because the comings and goings of people are frequent on weekdays at the time they report for work and at the time they leave the office.

### (Refrigerated Warehouse)

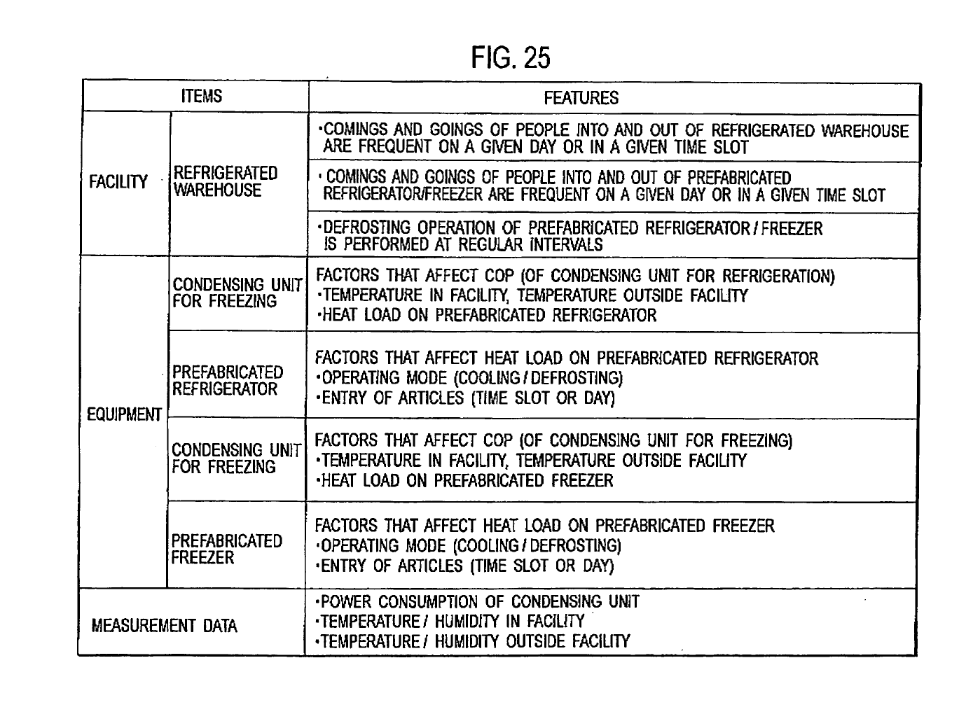

Description will be given below, taking as an example the refrigerated warehouse having features shown in FIG. 25. Incidentally, the refrigerated warehouse includes a prefabricated refrigerator, a condensing unit for refrigeration connected to the prefabricated refrigerator, a prefabricated freezer, and a condensing unit for freezing connected to the prefabricated freezer. The refrigerated warehouse is an example of the facility 10 provided with the freezers alone and not provided with the air conditioners. FIG. 25 is a table for explaining the features of the refrigerated warehouse according to an example of the present invention.

Specifically, as shown in FIG. 25, the refrigerated warehouse is characterized in that the comings and goings of people into and out of the warehouse are frequent on a given day or in a given time slot, the comings and goings of people into and out of the prefabricated refrigerator/freezer are frequent on a given day or in a given time slot, and the defrosting operation of the prefabricated refrigerator/freezer is performed at regular intervals. Also, in FIG. 25, there is shown an example where the operation condition of the equipment provided in the refrigerated warehouse can be acquired, but weather information cannot be acquired.

Here, the classification conditions for the refrigerated warehouse are selected based on the features of the refrigerated warehouse.

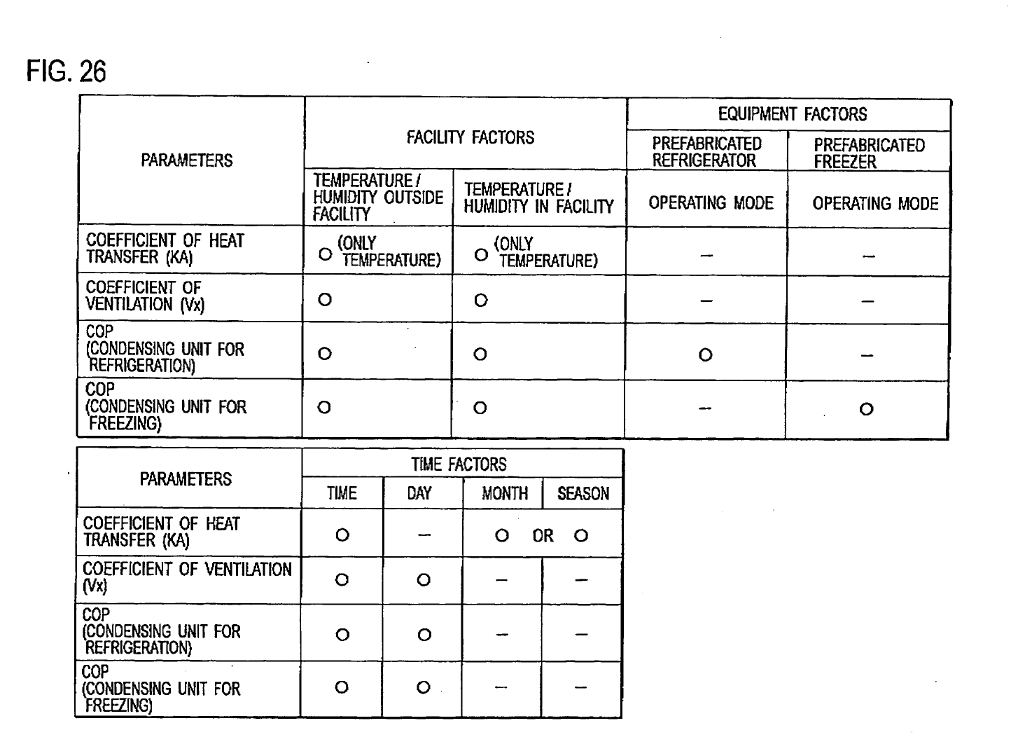

For example, for a heat balance model simplified for the refrigerated warehouse, as shown in FIG. 26, the facility factors, the equipment factors and the time factors are selected as the classification conditions. FIG. 26 is a table for explaining the classification conditions for the refrigerated warehouse according to an example of the present invention.

As for the COP (of the condensing unit for refrigeration/freezing), the COP is affected by the influence of the temperature and humidity in the facility or the temperature and humidity outside the facility or the like. Thus, it is preferable that the temperature and humidity in the facility or the temperature and humidity outside the facility be selected as the classification condition. The COP is affected by the operation condition (or the operating mode) of the prefabricated refrigerator/freezer, and thus, it is preferable that the operating mode (cooling/defrosting) of the prefabricated refrigerator/freezer be selected as the classification condition.

Preferably, the time and the day having correlation to the comings and goings of people are selected as the classification conditions, because the comings and goings of people into and out of the refrigerated warehouse are frequent on the given day or in the given time slot. Preferably, the time and the day having correlation to the entry of articles are selected as the classification conditions, allowing for a temporary increase in heat load at the time of entry of articles into the prefabricated refrigerator/freezer or the like.

As for the coefficient of heat transfer (KA), the coefficient of heat transfer (KA) is affected by the temperature in the facility or the temperature outside the facility. Thus, it is preferable that the temperature in the facility or the temperature outside the facility be selected as the classification condition. Preferably, the time, the month or the season having correlation to the temperature distribution or the radiation heat is selected as the classification condition, taking into account the influence of the temperature distribution or the sunlight radiation heat in the parts of the facility.

As for the coefficient of ventilation (Vx), the coefficient of ventilation (Vx) is affected by the temperature and humidity in the facility or the temperature and humidity outside the facility. Thus, it is preferable that the temperature and humidity in the facility or the temperature and humidity outside the facility be selected as the classification condition. Preferably, the time and the day having correlation to the comings and goings of people axe selected as the classification conditions, because the comings and goings of people into and out of the refrigerated warehouse axe frequent on the given day or in the given time slot.

### Other Embodiments

While the present invention has been described by way of the above-mentioned embodiments, it is to be understood that the description and drawings that form part of the present disclosure are not intended to limit the scope of the invention. From this disclosure, various alternative embodiments, examples and applicable technologies will be apparent to those skilled in the art.

For example, it is to be understood that the parameters required to construct the heat balance model are not limited to the parameters given as examples in the above-mentioned embodiments. Specifically, the parameters may be appropriately selected according to the type of the facility 10 (e.g., the convenience store, the supermarket, or the like).

It is to be understood that the measurement data required to identify the parameters is not limited to the measurement data given as an example in the above-mentioned embodiments. Specifically, the measurement data may be appropriately selected according to the type of the facility 10 (e.g., the convenience store, the supermarket, or the like).

Further, it is to be understood that the classification conditions that affect the parameters are not limited to the classification conditions given as examples in the above-mentioned embodiments. Specifically, the classification conditions may be appropriately selected according to the type of the facility 10 (e.g., the convenience store, the supermarket, or the like).

In the above-mentioned embodiments, the refrigerating showcase or the freezing showcase is given as an example of the showcase; however, it is to be understood that the showcase is not so limited. Specifically, heat-producing equipment such as a hot showcase may be contained in the facility 10. In this example, it is preferable that the time, the month or the season having correlation to a period of time during which the heat-producing equipment (e.g., the oden equipment, the fryer (or cookware) or a copying machine) is used be selected as the classification conditions that affect the COP (of the air conditioner).

If the heat-producing equipment is the oden equipment used in winter only, the month or the season is selected as the classification condition. If the heat-producing equipment is a ceiling light or the fryer (or cookware), the time, the day, the month or the season having correlation to the schedule of use of the ceiling light or the fryer (or cookware) is selected as the classification condition. If the heat-producing equipment is the copying machine, the time or the day having correlation to the operating time of the copying machine (or the comings and goings of people) is selected as the classification condition.

In the above-mentioned embodiments, description has been given taking the power consumption as an example of the energy consumption; however, it is to be understood that the energy consumption is not so limited. Specifically, gas consumption may be taken as the energy consumption, or both the power consumption and the gas consumption may be taken as the energy consumption.

A modeling program for implementing the operation of the modeling device 100 according to the above-mentioned embodiments (see FIGS. 5 and 6) may be provided. Likewise, a simulation program for implementing the operation of the simulation device 200 according to the above-mentioned embodiments (see FIG. 7) may be provided.

Of course, it will be here understood that the modeling program and the simulation program are stored in a readable medium such as a ROM or a RAM and are run on a computer including a CPU or the like.

A system for using a heat balance model, including the modeling device 100 and the simulation device 200 according to the above-mentioned embodiments, may be provided. Here, in the system for using a heat balance model, the structural components provided in the modeling device 100 and the structural components provided in the simulation device 200 may be distributed among multiple apparatuses wired or wirelessly connected. Further, a method for using a heat balance model, including the operation of the modeling device 100 and the simulation device 200, may be provided.

According to the system or method for using a heat balance model, it is a matter of course that the above-mentioned advantageous effects can be achieved by the modeling device 100 and the simulation device 200.

In the above-mentioned embodiments, the conductive heat load (Hd [kJ/s]) applied to the facility 10 is found by the following Equation (1); however, it is to be understood that the conductive heat load is not so limited.

Hd=KA(To−Ti) (1)

Specifically, Equation (1a) may be used to find the conductive heat load (Hd [kJ/s]) applied to the facility 10:

Hd=k×S×(To−Ti) (1a)

where k represents a coefficient of heat transmittance or a coefficient of heat transmission [kJ/m²/° C./s], and S represents the total area of the walls, roofs, glass windows, and the like of the facility 10.

In other words, the coefficient of heat transmittance or the coefficient of heat transmission (k) may be used as the parameter, in place of the coefficient of heat transfer (KA).

In the above-mentioned embodiments, the coefficient of ventilation (Vx [kg/s]) is used to calculate the ventilation heat load (Hx [kJ/s]) on the facility 10, as represented by the following Equation (2); however, it is to be understood that the ventilation heat load is not so limited.

Hx=Vx{H(To,Ho)−H(Ti,Hi)} (2)

Specifically, the ventilation heat load (Hx [kJ/s]) on the facility 10 may be a rate of air flow (Vx [kg/s]) into the facility 10, rather than the coefficient of ventilation (Vx [kg/s]).

In other words, the rate of air flow (Vx [kg/s]) may be used as the parameter, in place of the coefficient of ventilation (Vx [kg/s]).

In the above-mentioned embodiments, the coefficient of performance (COP) of the equipment is used as the parameter representing the relationship between the capabilities (e.g., the heating/cooling capability) of the equipment and the energy consumption of the equipment. Specific examples of the coefficient of performance (COP) include the following values:

(1) the ratio between the cooling/heating capability and the power consumption, if the air conditioner (or the outdoor unit) is an EHP (Electric Heat Pump);

(2) the ratio between the cooling/heating capability and the energy consumption (i.e., the power consumption plus the gas consumption), if the air conditioner (or the outdoor unit) is a GHP (Gas Heat Pump);

(3) the ratio between the cooling/heating capability and the energy consumption (i.e., the power consumption plus the gas consumption), if the air conditioner is an absorption refrigerating machine appliance;

(4) the ratio between the freezing capability and the power consumption (or input power), if the condensing unit is motor driven; and

(5) the ratio between the freezing capability and the energy consumption (i.e., the power consumption (or the input power) plus the gas consumption), if the condensing unit is gas engine driven.

Incidentally, this application is based on and claims priority of Japanese Patent Application Nos. 2006-244514 (filed on Sep. 8, 2006) and 2007-219840 (filed on Aug. 27, 2007), the entire contents of which are incorporated herein by reference.

### INDUSTRIAL APPLICABILITY

As described above, the present invention provides: a modeling device and a modeling program capable of easily constructing a heat balance model for predicting energy consumption of equipment with high accuracy when there is a change in equipment or a change in equipment settings, or for predicting energy consumption of equipment provided in a similar facility with high accuracy; a simulation device and a simulation program for predicting energy consumption of equipment using the heat balance model; and a method and a system for using the heat balance model.

1. A modeling device, comprising:
a classification unit configured to classify measurement data acquired in order to identify a parameter required to construct a heat balance model for a facility containing a plurality of equipments, according to classification conditions affecting the parameter; and
an identification unit configured to identify the parameter for each of the classification conditions, based on the measurement data classified for each of the classification conditions.

2. The modeling device according to claim 1, wherein the classification conditions are set in accordance with a facility factor including at least any one of temperature in the facility; humidity in the facility, temperature outside the facility, humidity outside the facility, and sensor information indicative of the opening and closing of an entrance door of the facility.

3. The modeling device according to claim 1, wherein the classification conditions are set in accordance with a time factor including at least any one of time, day, month and season.

4. The modeling device according to claim 1, wherein the classification conditions are set in accordance with a weather factor including at least any one of weather, precipitation and mean temperature.

5. The modeling device according to claim 1, wherein the classification conditions are set in accordance with an equipment factor including at least any one of information as to whether or not the equipment is in operating condition, operating mode of the equipment, a temperature set for the equipment, an air flow set for the equipment, whether a thermo-condition for temperature control of the equipment is on or off, and sensor information acquired relative to the equipment.

6. The modeling device according to claim 1, wherein the parameter is any one of a proportional coefficient used to calculate an amount of conductive heat flowing into and out of the facility or an amount of radiation heat flowing into the facility, a coefficient used to calculate an amount of ventilation heat flowing into and out of the facility, and a coefficient representing the relationship between capabilities of the equipment and energy consumption of the equipment.

7. A simulation device, comprising:
an acquisition unit configured to acquire a parameter for each of classification conditions affecting the parameter, the parameter required to construct a heat balance model for a facility containing a plurality equipments;
an extraction unit configured to receive a simulation condition, and extract a parameter which matches the simulation condition, from the parameter acquired for each of the classification conditions by the acquisition unit; and
a prediction unit configured to predict the energy consumption of the equipment, using the parameter extracted by the extraction unit,
wherein the parameter is identified based on measurement data classified according to the classification conditions.

8. A modeling program causing a computer to execute:
a step A of classifying measurement data acquired in order to identify a parameter required to construct a heat balance model for a facility containing a plurality of equipments, according to classification conditions affecting the parameter; and
a step B of identifying the parameter for each of the classification conditions, based on the measurement data classified according to the classification conditions.

9. A simulation program causing a computer to execute:
a step C of acquiring a parameter for each of classification conditions affecting the parameter, the parameter required to construct a heat balance model for a facility containing a plurality of equipments;
a step D of receiving a simulation condition, and extracting a parameter which matches the simulation condition, from the parameter acquired for each of the classification conditions at the step C; and
a step E of predicting the energy consumption of the equipment, using the parameter extracted at the step D,
wherein the parameter is identified based on measurement data classified for each of the classification conditions.

10. A method for using a heat balance model, comprising:
a step A of classifying measurement data acquired in order to identify a parameter required to construct the heat balance model for a facility containing a plurality of equipments, for each of classification conditions affecting the parameter;
a step B of identifying the parameter for each of the classification conditions, based on the measurement data classified for each of the classification conditions;
a step C of acquiring the parameter identified at the step B, for each of the classification conditions;
a step D of receiving a simulation condition, and extracting a parameter which matches the simulation condition, from the parameter acquired for each of the classification conditions at the step C; and
a step E of predicting energy consumption of the equipment, using the parameter extracted at the step D.

11. A system for using a heat balance model, comprising:
a classification unit configured to classify measurement data acquired in order to identify a parameter required to construct a heat balance model for a facility containing a plurality of equipments, according to classification conditions affecting the parameter;
an identification unit configured to identify the parameter for each of the classification conditions, based on the measurement data classified according to the classification conditions;
an acquisition unit configured to acquire the parameter identified by the identification unit, for each of the classification conditions;
an extraction unit configured to receive a simulation condition, and extract a parameter which matches the simulation condition, from the parameter acquired for each of the classification conditions by the acquisition unit; and
a prediction unit configured to predict energy consumption of the equipment, using the parameter extracted by the extraction unit.
